(19) United States
(12) Patent Application Publication
(10) Pub. No.: US 2015/0309895 A1
(43) Pub. Date: Oct. 29, 2015

(54) DECISION-MAKING SUPPORT SYSTEM AND DECISION-MAKING SUPPORT METHOD

(71) Applicant: Hitachi, Ltd., Tokyo (JP)

(72) Inventors: KOUICHI TANIMOTO, Tokyo (JP); Junji OGASAWARA, Tokyo (JP)

(73) Assignee: Hitachi, Ltd., Tokyo (JP)

(21) Appl. No.: 14/694,608

(22) Filed: Apr. 23, 2015

(30) Foreign Application Priority Data
Apr. 25, 2014 (JP) 2014-092019

(51) Int. Cl. G06F 11/20; H04L 29/08

(52) U.S. Cl. CPC G06F 11/2033; H04L 67/10; G06F 2201/805

(57) ABSTRACT

A decision-making support device configured to store a predetermined criterion defining a damage degree according to a content of each of disasters, and predetermined information symbolizing various human activities in disasters, and configured to determine a damage degree for each of areas at a disaster-stricken area by comparing disaster information acquired from a predetermined interface with a predetermined criterion, determine an activity degree of human activities for each of the areas based on appearance frequency of predetermined information in various types of information acquired from a predetermined interface or disaster information, identify, as a support-needed area, an area with a higher damage degree and a lower activity degree than those of other areas, or an area with the damage degree and the activity degree higher by a predetermined level or more than those of other areas, and output information of the support-needed area to a predetermined device.

### CROSS-REFERENCE TO RELATED APPLICATIONS

The present application claims priority pursuant to 35 U.S.C. §119 from Japanese patent application no. 2014-92019, filed on Apr. 25, 2014, the entire disclosure of which is hereby incorporated herein by reference.

### BACKGROUND OF THE INVENTION

1. Field of the Invention

The present invention relates to a decision-making support system and a decision-making support method. Specifically, the present invention relates to a technique that enables appropriate and smooth establishment of a cooperative framework among organizations in decision making for disaster response, and an appropriate disaster response according to actual situations in the disaster-stricken area.

2. Related Art

For response to a developmental event, it is important to properly figure out the event concerned and relevant situations. For example, when the event is a disaster, authorities of the government and local institutions need to figure out damage situations in a prompt and precise manner for the appropriate response according to actual situations in order to cope with the disaster (such as rescue of disaster victims, infrastructure restoration, and evacuation guiding). When carrying out such a disaster response, resources for the disaster response need to be managed to allocate a support workforce and additional material and equipment to a site where workforce, material and equipment, etc. are running short.

For solving the problem that prompt planning and issuing measures cannot be made due to a time taken for communication and sharing of damage situations at the time of disaster occurrence, a posted image system (see Japanese Laid-open Patent Publication No. 2011-248708) that enables simple sharing of a site image taken by a portable terminal device as information is proposed as a technique of supporting the situation finding at the time of disaster.

Further, with such purposes of determining task centralization to a coordination leader in emergency and avoiding occurrence of a bottle neck in the entire emergency task, an emergency coordination support device (see Japanese Laid-open Patent Publication No. 2013-045267) that manages progress in the disaster response task and necessary workforce and time for performing thereof, and determines task centralization to a coordination leader, and the like is proposed as well.

### SUMMARY OF THE INVENTION

For example, a disaster of a large scale is likely to cause the need to perform the disaster response by mutual cooperation among multiple organizations. However, there is a problem that an area in need of the support and the detail of the needed support cannot be determined easily because actual situations of the disaster site and needs therefrom are unknown, despite of willingness to support.

Also, there is a problem that since the summarization of requests and communications of information among organizations take many steps due to involvement of multiple organizations in the disaster response, grasping of situations by a decision maker of each organization, and determining and coordinating of the support and its detail is difficult or likely to be delayed. Also, a site organization receiving a support from the above organizations at the disaster site has a problem that it cannot easily determine what kind of the disaster response should be performed with which supporter.

In view of the foregoing problems, it is an object of the present invention to provide a technique that enables, in a decision making for disaster response, to establish a cooperative framework among organizations in an appropriate and smooth manner and perform an appropriate disaster response according to actual situations at the disaster-stricken area.

A decision-making support system according to the present invention, which solves the foregoing problems, includes a decision-making support device comprising a storage device configured to store a predetermined criterion defining a damage degree according to a content of each of disasters, and predetermined information symbolizing various human activities in disasters, and an arithmetic device configured to determine a damage degree for each of areas in a disaster-stricken area by comparing disaster information acquired via a predetermined interface with the predetermined criterion, determine an activity degree of human activities at each of the areas based on appearance frequency of the predetermined information in various types of information acquired from the predetermined interface or the disaster information, identify, as a support-needed area, an area with a higher damage degree and a lower activity degree than those of other areas, or an area with the damage degree and the activity higher by a predetermined level or more than those of other areas, and output information of the support-needed area to a predetermined device.

Also, a decision-making support system according to the present invention includes a server device configured to provide, on a network, at least any one of a decision-making support device, a site coordination device, a site responder terminal, and an information analysis device, as a cloud service; and a user terminal configured to access to the server device and utilize the cloud service for at least any one of the decision-making support device, the site coordination device, the site responder terminal, and the information analysis device, wherein the decision-making support device comprises: a storage device configured to store a predetermined criterion defining a damage degree according to a content of each of disasters, and predetermined information symbolizing various human activities in disasters; and an arithmetic device configured to determine a damage degree for each of areas at a disaster-stricken area by comparing disaster information acquired from a predetermined interface with the predetermined criterion, determine an activity degree of human activities for each of the areas based on appearance frequency of the predetermined information in various types of information acquired from a predetermined interface or the disaster information, and identify, as a support-needed area, an area with a higher damage degree and a lower activity degree than other areas, or an area with the damage degree and the activity degree higher by a predetermined level or more than those of other areas, and output information of the support-needed area to a predetermined device, the site coordination device comprises: a storage device configured to store location information and attribute information on each of site responders of various organizations performing a disaster response activity at a disaster-stricken area; and an arithmetic device configured to identify a site responder of another organization located within a predetermined range from a location of a predetermined site responder based on the location information on the site responders; identify, based on the attribute information, a site responder having an activity purpose identical or similar to the predetermined site responder out of the identified site responders of the other organization; and notify information of the identified site responder of the other organization as information of a cooperation and coordination candidate to a site responder terminal used by the predetermined site responder, the site responder terminal comprises an arithmetic device configured to receive information of the cooperation and coordination candidate from the site coordination device, and according to an instruction from a site responder via a predetermined interface, transmit a cooperation and coordination request for a disaster response activity to a site responder terminal used by a site responder of the other organization being the cooperation and coordination candidate, and the information analysis device comprises an arithmetic device configured to analyze occurrence information of a predetermined event acquired from a predetermined interface with a predetermined algorithm, identify a range of impact by the predetermined event, identify, based on the location information retained in the site coordination device, a site responder located in the range, and an impact of the predetermined event on the site responder, and notify at least information of the predetermined event and an impact thereof to a site responder terminal of the site responder.

A decision-making support method according to the present invention is a method in which a decision-making support device including a storage device configured to store a predetermined criterion defining a damage degree according to a content of each of disasters performs: determining a damage degree for each of areas at a disaster-stricken area by comparing disaster information acquired from a predetermined interface with the predetermined criterion; determining an activity degree of human activities for each of the areas based on appearance frequency of the predetermined information in various types of information acquired from the predetermined interface or the disaster information; identifying, as a support-needed area, an area with a higher damage degree and a lower activity degree than those of other areas, or an area with the damage degree and the activity degree higher by a predetermined level or more than those of other areas; and outputting information of the support-needed area to a predetermined device.

The present invention enables, in a decision making for the disaster response, to establish a cooperative framework among organizations in an appropriate and smooth manner and perform an appropriate disaster response according to actual situations at the disaster-stricken area.

### BRIEF DESCRIPTION OF THE DRAWINGS

FIG. 1 is an overall configuration example of a decision-making coordination system according to the embodiment;

FIG. 2 is an example of a typical device configuration and software configuration in the decision-making coordination system according to the embodiment;

FIG. 3 is a hardware configuration example of devices in the decision-making coordination system according to the embodiment;

FIG. 4 is an example of a decision-making support concept according to the embodiment;

FIG. 5 is a procedure example 1 of a decision-making support method according to the embodiment;

FIG. 6 is a procedure example 2 of the decision-making support method according to the embodiment;

FIG. 7 is a configuration example of a map database according to the embodiment;

FIG. 8 is a configuration example of a support area extraction database according to the embodiment;

FIG. 9 is a configuration example of a resource database according to the embodiment;

FIG. 10 is a configuration example of a site coordination database according to the embodiment;

FIG. 11 is a transition example 1 of a display screen according to the embodiment;

FIG. 12 is a transition example 2 of the display screen according to the embodiment;

FIG. 13 is a flowchart showing a procedure example 3 of the decision-making support method according to the embodiment;

FIG. 14 is a flowchart showing a procedure example 4 of the decision-making support method according to the embodiment;

FIG. 15 is a configuration example of a coordination destination database according to the embodiment;

FIG. 16 is a transition example 3 of the display screen according to the embodiment;

FIG. 17 is a transition example 4 of the display screen according to the embodiment;

FIG. 18 is a flowchart showing a procedure example 5 of the decision-making support method according to the embodiment;

FIG. 19 is a flowchart showing a procedure example 6 of the decision-making support method according to the embodiment;

FIG. 20 is a configuration example of a collected information database according to the embodiment;

FIG. 21 is a configuration example of a disclosed information management database according to the embodiment;

FIG. 22 is a configuration example of an analysis result database according to the embodiment;

FIG. 23 is a transition example 5 of the display screen according to the embodiment;

FIG. 24 is a display screen example 1 according to the embodiment;

FIG. 25 is a transition example 5 of the display screen according to the embodiment;

FIG. 26 is a flowchart showing a procedure example 7 of the decision-making support method according to the embodiment;

FIG. 27 is a flowchart showing a procedure example 8 of the decision-making support method according to the embodiment;

FIG. 28 is a configuration example of a plan database according to the embodiment;

FIG. 29 is a configuration example of a joint plan database according to the embodiment;

FIG. 30 is a transition example 6 of the display screen according to the embodiment;

FIG. 31 is a transition example 7 of the display screen according to the embodiment; and

FIG. 32 shows a provision form example of a cloud service compatible with the decision-making support system according to the embodiment.

### DETAILED DESCRIPTION OF THE INVENTION

System Configuration

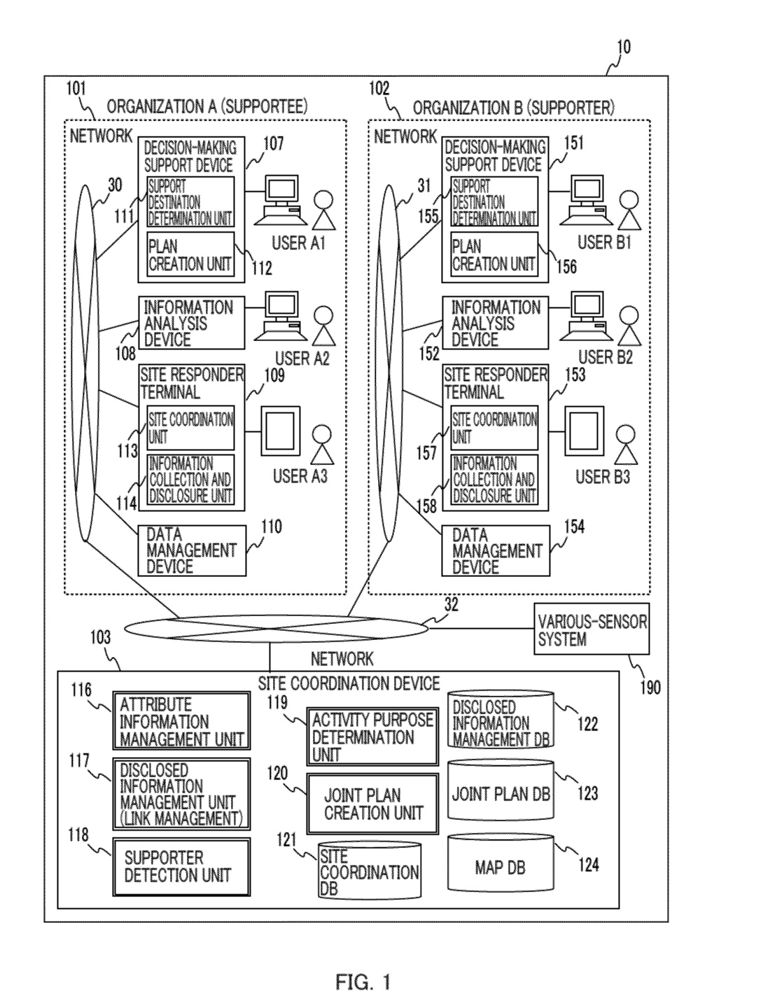

Hereinafter, embodiments of the present invention are described in detail by using the accompanying drawings. FIG. 1 is an overall configuration example of a decision-making coordination system according to the embodiment. The decision-making support system 10 illustrated in FIG. 1 is a computer system that enables, in a decision making for the disaster response, to establish a cooperative framework among organizations in an appropriate and smooth manner and perform an appropriate disaster response according to actual situations at the disaster-stricken area. In this embodiment, a form of the disaster response performed by each of the above organizations working for the disaster response by using a decision-making coordination system, and a site coordination device operated by any one of the organization or jointly among the organizations is described.

As illustrated in FIG. 1, decision-making coordination systems 101, 102 in the decision-making support system 10 according to the embodiment are systems utilized respectively by a supportee (for example, Organization A) receiving a support from other organizations in the disaster response, and a supporter (for example, Organization B) supporting the supportee, to collect, manage, and analyze damage-related information for preparation of details of the disaster response for site responders located at the disaster site, generation of the disaster response plan, and cooperation and coordination with other coordinating organizations regarding the disaster response. In the description below, decision-making coordination systems 101, 102 are collectively referred to as the decision-making coordination system 101, unless specifically distinguished between the organizations.

The decision-making coordination systems 101, 102 are connected to each other via a network 32 such as the internet in a manner enabling mutual communication. Similarly, decision-making coordination systems 101, 102 of each organization are capable of communicating with a site coordination device 103 via the network 32. The decision-making coordination systems 101, 102 receive data transmitted from a various-sensor system 190 of each parent organization or another organization via the network 32. The various-sensor system 190 is an information system that provides word-of-mouth information of a sensor for detecting or measuring a disaster-related event such as a seismometer and a river water level gauge, a mass communication or internet information media system, a disaster prevention system of a disaster prevention-related institution, a traffic monitoring system monitoring road traffic situation, SNS (Social Networking Service), etc.

The site coordination device 103 is a server device configured to collect and manage disclosed information (described later) transmitted from the decision-making coordination systems 101, 102, and information (such as, for example, the location and the operation content of the site responder) relating to the status of each organization performing the disaster response.

The above decision-making coordination systems are systems provided for each of organizations. Instead of two systems as illustrated in FIG. 1, at least three decision-making coordination systems may be included in the decision-making support system 10 depending on the number of organizations. Also, multiple site coordination devices 103 and multiple various-sensor systems 190 may be included in the decision-making support system 10. Information transmitted and received via the network 32 may include text information, location information, time information, voice information, image, video image, and caller-related information, etc.

Next, examples of a typical device configuration and software configuration in the decision-making coordination systems 101, 102, and the site coordination device 103 according to the embodiment are described. The decision-making coordination system 101 comprises a decision-making support device 107, an information analysis device 108, a site responder terminal 109, and a data management device 110. Similarly, the decision-making coordination system 102 comprises a decision-making support device 151, an information analysis device 152, a site responder terminal 153, and a data management device 154.

A user utilizing the decision-making support device 107 is referred to as a user A1, a user utilizing the information analysis device 108 as a user A2, and a user utilizing the site responder terminal 109 as a user A3. Assume that users A1, A2, and A3 belong to the above Organization A. Similarly, a user utilizing the decision-making support device 151 is referred to as a user B1, a user utilizing the information analysis device 152 as a user B2, and a user utilizing the site responder terminal 153 as a user B3. Assume that users B1, B2, and B3 belong to the above Organization B. As a matter of course, the organizations A and B are separate from each other. For example, when viewed from the Organization A, the Organization B is a separate organization. Thus, the parent organization and the user of the decision-making coordination systems 101, 102 are different from each other, but the device configuration and the software configuration thereof are identical with each other.

The above decision-making coordination system 101 comprises a decision-making support device 107, an information analysis device 108, a site responder terminal 109, and a data management device 110, and the devices are connected with each other via the network 30 in a manner enabling mutual exchange of data. Here, the network 30 may be a public line such as the internet, or a local network within the organization. The number of each device may be two or more. For example, when two or more site responders exist (for example, a user A3), each of the site responders may hold and use a site responder terminal 109 for exclusive use.

The decision-making support device 107 comprises, as functions thereof, a support destination determination unit 111 configured to present a support destination candidate (support-needed area) at the time of disaster occurrence to a decision maker (for example, user A1) of the parent organization, generate a disaster response plan for dispatch a site responder (support unit) to the disaster-stricken area, and communicate instructions to relevant site responders, and a plan creation unit 112 configured to present a candidate of the cooperating and coordinating party destination organization, and create a disaster response plan jointly with the cooperating and coordinating party destination organization.

The information analysis device 108 implements a function for an information analyst (for example, user A2) assisting a decision maker (for example, user A1), and a site responder (for example, user A3) to analyze data accumulated in the data management device 110 and data disclosed by a decision-making coordination system of the other organization, and estimate present situations and developments at the disaster-stricken area, and impacts thereof on the disaster response.

The site responder terminal 109 includes, as functions for a site responder (for example, user A3) performing disaster response operations such as life-saving and road restoration at the disaster-stricken area, a site coordination unit 113 configured to receive instructions from the above decision maker and the information analyst, transmit situations of the site responder (such as the present location and the operation content), and exchange data involved in the cooperation and coordination with the decision-making coordination system 102 of the other organization (supporter), and an information collection and disclosure unit 114 configured to transmit data entered by the site responder to the data management device 110, or to the site coordination device 103 and the decision-making coordination system 102 of the other organization.

The above decision-making coordination systems 101, 102 are operated in a building or server room of each organization, or in a data center or the like located physically apart from the organization's location. The decision-making support device 107, the information analysis device 108, and the site responder terminal 109 may be used by a same user.

The site coordination device 103 implements an attribute information management unit 116, a disclosed information management unit 117, a supporter detection unit 118, an activity purpose determination unit 119, and a joint plan creation unit 120. The attribute information management unit 116 is configured to receive attribute information including the activity area (destination), the parent organization, the unit name, the workforce, the present location (such as GPS data), the operation content, the shortage of workforce, equipment and material of each site responder from the above site responder terminals 109 (Organization A), 153 (Organization B), and register the information into a site coordination DB 121.

The above disclosed information management unit 117 is configured to receive data disclosed among organizations, or link destination information for access to the data from the decision-making coordination systems 101 and 102, register the data into a disclosed information management DB 122, and transmit data registered in the disclosed information management DB 122 to the decision-making coordination systems 101 and 102.

The above supporter detection unit 118 is configured to detect a site responder of the other organization located within an activity range of each site responder whose attribute information is registered in the site coordination DB 121.

The above activity purpose determination unit 119 is configured to determine the consistency between attribute information of each site responder whose attribute information is registered in the site coordination DB 121, and attribute information of a site responder of the other organization detected by the above supporter detection unit 118, extract a site responder suitable for cooperation and coordination from site responders of the other organization detected by the above supporter detection unit 118, and notify the suitable site responder to each site responder.

The above joint plan creation unit 120 is configured to provide the same screen to, for example, the decision-making coordination system 101 or 102 by using such information, for example, as map data or satellite image, topographic information, building information, and population information stored in a map DB 124, receive input of the user A1 and the user B1, and create and register a joint plan for the disaster response in a joint plan DB 123.

The above site coordination device 103 may be operated by the Organization A being the supportee, by integrating, for example, into the decision-making coordination system 101, or may be operated by the Organization B being the supporter, by integrating into the decision-making coordination system 102.

Information processed by decision-making coordination systems 101, 102, and the site coordination device 103 includes text information, location information, time information, voice information, image, video image, and information on a provider of other information. Here, the location information may be acquired, for example, by a device transmitting the information by using a GPS (Global Positioning System) unit provided therein or by utilizing a radio wave transmitted from a base station of a mobile phone used for communication (existing technique).

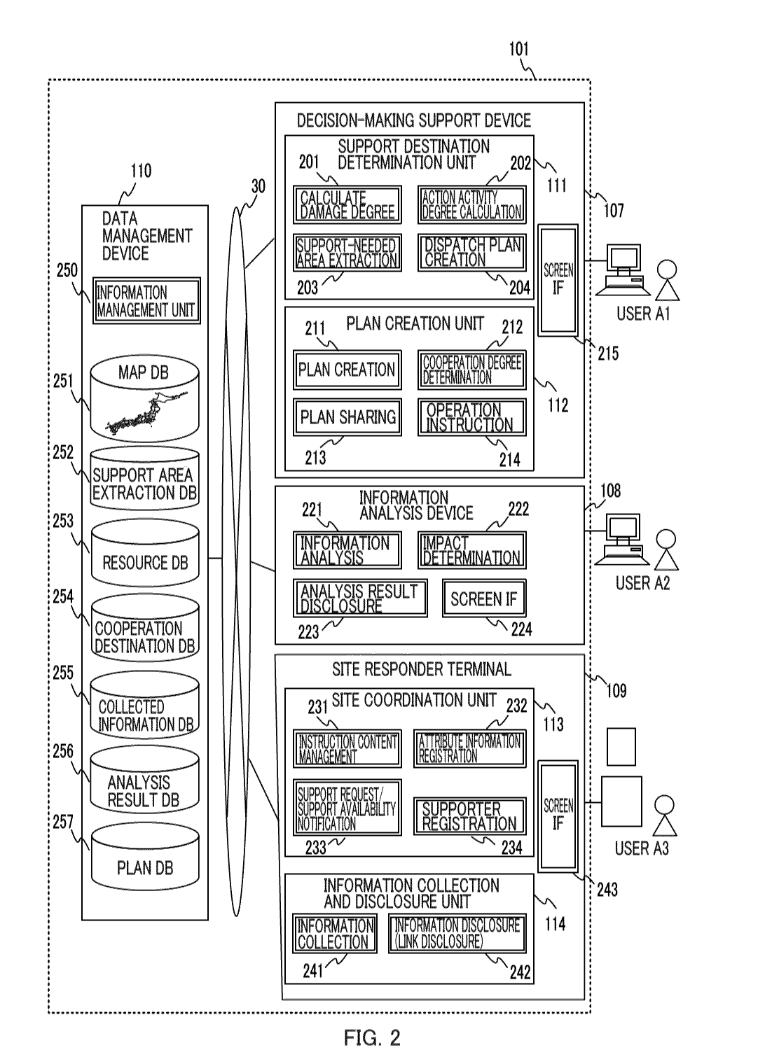

Then, an example of a typical device configuration and software configuration of the decision-making coordination system 101 as a main component of the decision-making support system 10 is described in more detail. FIG. 2 is an example of a typical device configuration and software configuration in the decision-making coordination system 101 according to the embodiment.

The support destination determination unit 111 of the decision-making support device 107 implements a damage degree calculation function 201, an action activity degree calculation function 202, a support-needed area extraction function 203, and a dispatch plan creating function 204.

The damage degree calculation function 201 collects disaster information for each of areas forming the disaster-stricken area (example: areas divided in the disaster-stricken district by a certain range of longitude and latitude), and calculates a value (herein referred to as the damage degree) normalized among subareas. The disaster information includes the seismic intensity, estimated building damage, estimated human damage, estimated flood, estimated tsunami damage, estimated fire occurrence and fire spread, estimated life line damage, etc., collected from a various-sensor system 190, the site responder terminal 109, and the information analysis device 108.

The action activity degree calculation function 202 performs text analysis, voice analysis, image/video analysis and the like for SNS information on the internet, and news report information of the television, radio, and the like acquired from above various-sensor system 190, extracts information on the personnel, the organization, and movements of vehicles, material, and equipment, calculates the number of information for each of the above areas, and calculates a value normalized among areas (herein referred to as the action activity degree).

The support-needed area extraction function 203 is configured to extract, as the support-needed area, an area with a high damage degree and a low action activity degree, or an area with the extremely high damage degree and action activity degree compared with other areas, by utilizing the damage degree calculated by the above damage degree calculation function 201, and the action activity degree calculated by the action activity degree calculation function 202.

The dispatch plan creating function 204 is configured to create the instruction (activity destination and operation content of the disaster response) to a site responder, and transmit the instruction to the site responder terminal 109 of the site responder.

When collecting various types of disaster information, the damage degree calculation function 201 may give weighting to an event depending on the impact thereof. For example, total value of the disaster information for tsunami damage may be counted to double. Disaster information (such as, for example, information of fire occurrence and landslide occurrence) may be extracted from news report or SNS information on areas by keyword retrieval (a keyword for retrieval is retained in advance), and the number of extracted pieces of disaster information may be used as the damage degree of the corresponding area.

The plan creation unit 112 of the decision-making support device 107 implements a cooperation degree determining function 212, a plan sharing function 213, and a work instructing function 214.

The cooperation degree determining function 212 is configured to determine the cooperation degree between a plan creation function 211 and the other organization, the plan creation function 211 being configured to create a disaster response plan comprising the work place, time, operation content, and the like for each site responder, and register the disaster response plan in a plan DB 257.

The plan sharing function 213 is configured to transmit a cooperation and coordination request to the other cooperating and coordinating organization based on the cooperation degree determination result, or receive a cooperation and coordination request from the other organization, and if coordinating with the other organization, transmit a portion or whole of the disaster response plan registered in the plan DB 257 to the site coordination device 103.

The work instructing function 214 is configured to transmit information such as the work place, time, and operation content for the disaster response to a site responder terminal 109 of each site responder based on the disaster response plan created by the plan creation function 211.

The information analysis device 108 implements an information analysis function 221, an impact determination function 222, and an analysis result disclosure function 223.

The information analysis function 221 is configured to estimate present situations and changes of a predetermined event at the disaster-stricken area, and impact thereof on the disaster response (site responder therefor) from information registered in a collected information DB 255, and information analysis result registered in an analysis result DB 256, and register in the analysis result DB 256 as the analysis result.

The impact determination function 222 is configured to determine whether the above analysis result gives an impact on each site responder (for example, user A3), and, if any impact is determined, transmits the analysis result to the site responder terminal 109 of each site responder.

The analysis result disclosure function 223 is configured to receive notification from the site coordination device 103 that the analysis result has been disclosed by the other organization, acquire the analysis result from the disclosed information management DB 122 of the site coordination device 103, or the analysis result DB 256 of the decision-making coordination system 102 of the other organization, and register the acquired analysis result in the analysis result DB 256 of the data management device 110 of the own organization. Also, the analysis result disclosure function 223 registers a user (for example, a user who is authorized by the decision maker and instructed by the decision maker through an input device or the like) authorized to access to the analysis result registered in the analysis result DB 256. Further, the analysis result disclosure function 223 transmits an analysis result to be disclosed out of the analysis result registered in the analysis result DB 256, or information (such as URL) necessary for access to the analysis result to be disclosed, to the site coordination device 103 along with information on the user authorized to access.

The site coordination unit 113 of the site responder terminal 109 implements an instruction content management function 231, an attribute information registration function 232, a support request/support availability notification function 233, and a supporter registration function 234.

The instruction content management function 231 is configured to receive the dispatch destination (place) and the operation content (such as information collection and life-saving) of the site responder, and information necessary for operations (such as the map and damage status at the dispatch destination), transmitted from the decision-making support device 107.

The attribute information registration function 232 is configured to transmit, to the site coordination device 103, as attribute information, information on the place such as the dispatch destination, and destination of the above site responder, name of the parent organization or the unit, the contact (such as information for access to the site responder terminal 109), and information of the parent unit such as the number of workforce, retained material and equipment, present location (directly entered by the site responder, or acquired from GPS provided on the site responder terminal 109), the operation content, and the shortage information (such as workforce, material and equipment).

The support request/support availability notification function 233 is configured to receive attribute information of the site responder of the other organization being a cooperation and coordination candidate, from the site coordination device 103, transmit a cooperation and coordination request including the attribute information to a site responder terminal of the site responder, and receive a cooperation and coordination request from a site responder terminal 109 of the other organization. The support request/support availability notification function 233 transmits the response as to the availability of cooperation and coordination with the cooperation and coordination candidate received from a site responder being an operator of the site responder terminal 109 through an input device or the like, together with the attribute information, if cooperation and coordination is available, to a site responder terminal 109 of the other organization being the transmission source of the cooperation and coordination request.

The supporter registration function 234 is configured to receive the response as to the cooperation and coordination availability from a site responder terminal 109 being the transmission destination of the cooperation and coordination request, and, if the response indicates the availability of cooperation and coordination, register attribute information of a site responder of the transmission destination of the cooperation and coordination request in a cooperation destination DB 254. Also, the supporter registration function 234 notifies a site responder terminal 109 at the transmission destination of the cooperation and coordination request that the above attribute information has been registered. Similarly, upon receiving a notification from a site responder terminal 109 of the transmission source of the cooperation and coordination request that the attribute information has been registered in a coordination destination DB 254, the supporter registration function 234 registers attribute information of the site responder of the transmission source of the cooperation and coordination request in a cooperation destination DB 254.

Attribute information on respective site responders exchanged between cooperation and coordination request transmission sources may be directly transmitted or received between site responder terminals as described above, or may be acquired by a site responder terminal from the site coordination DB 121 of the site coordination device 103 wherein the attribute information is stored.

The information collection and disclosure unit 114 of the site responder terminal 109 implements an information collection function 241, and an information disclosure function 242.

The information collection function 241 is configured to register, in the collected information DB 255, text information, location information, time information, voice information, image data, video data, and the like entered by the site responder, or acquired from a predetermined device in the relevant site responder terminal 109, or from the various-sensor system 190 described above. Also, the information collection function 241 receives a notification from the site coordination device 103 that information has been disclosed by the other organization, and acquires text information, location information, time information, voice information, image data, and video data from the disclosed information management DB 122 of the site coordination device 103, or the collected information DB 255 of a decision-making coordination system 102 of the other organization.

The information disclosure function 242 is configured to register a user who is determined by a predetermined user such as the decision maker to be a user authorized to access to information registered in the collected information DB 255. Further, the information disclosure function 242 transmits information to be disclosed out of information registered in the collected information DB 255, or information (such as URL) necessary for access to the information to be disclosed, to the site coordination device 103 along with information on the user authorized to access as described above.

The data management device 110 implements an information management function 250. The information management function 250 is configured to receive information transmitted from at least any one of various sensor devices such as the seismometer and the river water level gauge, information media such as the news report and internet (SNS, home page, and the like), various-sensor system 190 such as disaster prevention systems retained by disaster prevention-related institutions, the decision-making support device 107, the information analysis device 108, the site responder terminal 109, and the site coordination device 103, and register into the database or transmit information preregistered in the database to each of the above devices.

Databases, in which such information is registered, include a map DB 251, a support area extraction DB 252, a resource DB 253, the coordination destination DB 254, the collected information DB 255, the analysis result DB 256, and the plan DB 257.

The map DB 251 is a database that stores map data, satellite image, topographic information, building information, population information, and the like.

The support area extraction DB 252 is a database that stores the damage degree calculated by the damage degree calculation function 201, and the action activity degree calculated by the action activity degree calculation function 202.

The resource DB 253 is a database that stores information on users in the organization and the unit (team) formed by multiple users (site responders), including information on the place such as the dispatch destination or destined place of the disaster response, name of the parent organization or unit, the contact (such as information for access to the site responder terminal 109), the number of workforce in the unit, the retained material and equipment, the present location, the operation content, and the shortage information (such as workforce, material and equipment).

The coordination destination DB 254 is a database that stores a portion or whole of attribute information of the cooperation and coordination request source user and the coordination source request destination user.

The collected information DB 255 is a database that stores text information, location information, time information, voice information, image, and video image in conjunction with a portion or whole of attribute information of the information creator (such as the sensor, site responder, and mass communication).

The analysis result DB 256 is a database that stores the analysis result in conjunction with a portion or whole of the attribute information of the analysis result creator.

The plan DB 257 is a database that stores the disaster response plan for each user (site responder) comprising the work location, time, and work content for the disaster response.

The above decision-making support device 107 includes a screen interface (hereinafter referred to as the screen IF) 215 configured to display data outputted by the support destination determination unit 111 or the plan creation unit 112, display such data by mapping on map data or satellite image contained in the map DB 251 according to information indicating the geographic location such as longitude, latitude, and altitude contained in each data, or receive input from the user.

Similarly, the information analysis device 108 includes a screen IF 224 configured to display data outputted by each function, or display data by mapping on map data or satellite image contained in the map DB 251 based on information indicating the geographic location such as longitude, latitude, and altitude contained in each data, or receive input from the user.

Similarly, the site responder terminal 109 includes a screen IF 243 configured to display data outputted by the site coordination unit 113 or the information collection and disclosure unit 114, or display data by mapping on map data or satellite image contained in the map DB 251 based on information indicating the geographic location such as longitude, latitude, and altitude contained in each data, or receive input from the user.

Such information displayed on each screen IF is not limited to those described above, but may include information managed by the data management device 110.

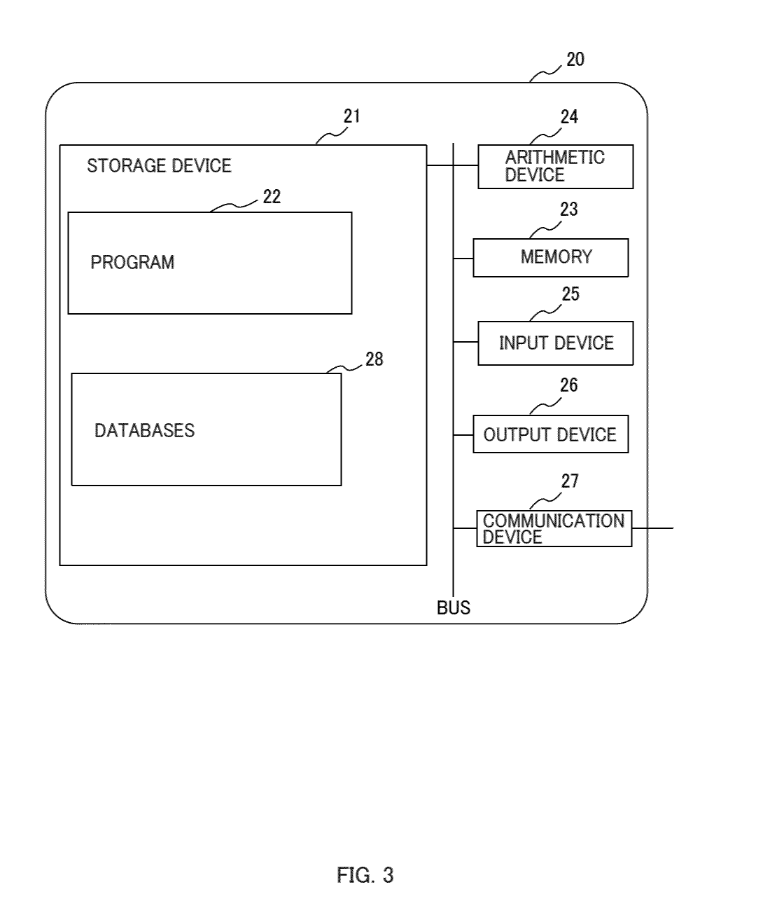

Here, an example of the hardware configuration of above devices forming the decision-making support system 10 is described. FIG. 3 is a hardware configuration example of the devices included in the decision-making support system 10 according to the embodiment. All of above devices, namely, the site coordination device 103, the decision-making support device 107, the information analysis device 108, the site responder terminal 109, and the data management device 110 are implemented by a computer 20.

The computer 20 includes a storage device 21 comprising an appropriate nonvolatile storage element such as a SSD (Solid State Drive) or a hard disk drive, a memory 23 comprising a volatile storage element such as a RAM, an arithmetic device 24 such as a CPU configured to read a program 22 stored in the storage device 21 into the memory 23, and perform integrated control of the computer itself as well as various determinations, arithmetic operation, and control processing, an input device 25 configured to receive key input or voice input from the user, an output device 26 such as a display configured to display processed data, and a communication device 27 connected to a network to perform communication processing with the other device. The storage device 21 stores the program 22 for implementing functions necessary for devices forming the decision-making support system 10 according to the embodiment, as well as various databases 28, as appropriate.

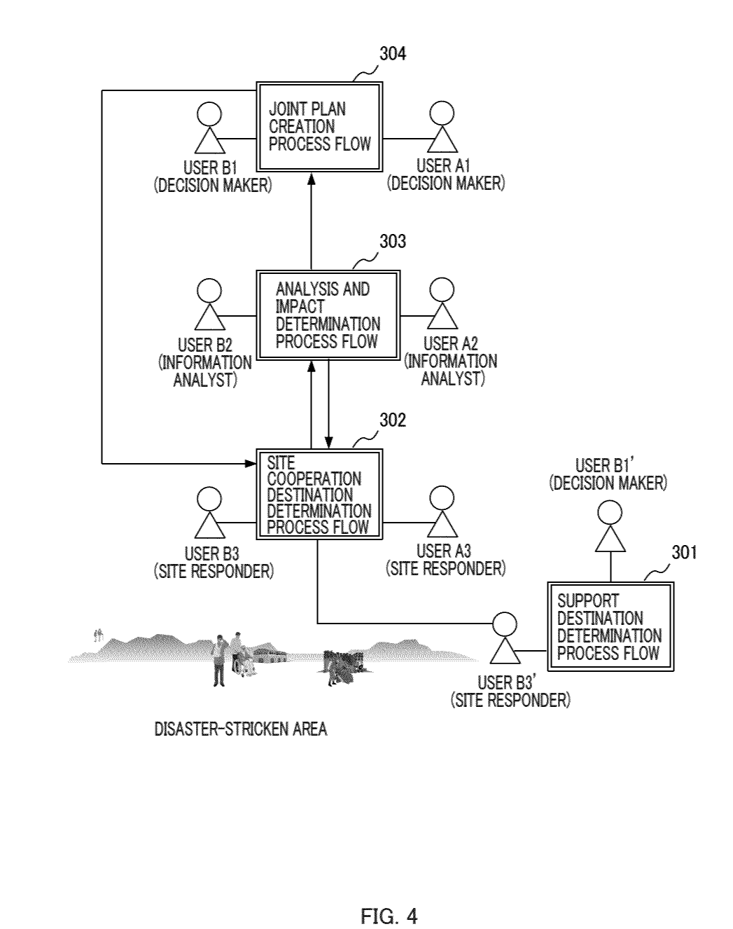

Next, the decision-making support concept of the embodiment is illustrated in the form of a simplified process flow. FIG. 4 is an example of the decision-making support concept of the embodiment. This process flow comprises a support destination determination process flow 301, a site coordination destination determination process flow 302, an analysis and impact determination process flow 303, and a joint plan creation process flow 304.

In the support destination determination process flow 301, the decision-making support device 107 operated by the user B1′ of the decision maker calculates the damage degree and the action activity degree from the above SNS information, simulation results, and the like, identifies the area needing the support or the support-needed area, determines the support destination, and issues the support destination instruction (dispatch instruction) to the site responder terminal 109 of the user B3′ being the site responder. On the other hand, the site responder terminal 109 of the user B3′ being the site responder receives and displays the above support destination instruction (dispatch instruction), and causes the user B3′ to view the instruction.

In the site coordination destination determination process flow 302, the site coordination device 103 receives attribute information from a site responder terminal 109 of each site responder (for example, user A3 and user B3) and registers in the site coordination DB 121. Then, based on attribute information of each site responder registered therein, the site coordination device 103 transmits attribute information of a user (for example, user B3) being the cooperation and coordination candidate to a site responder terminal of a user (for example, user A3) expected to need the cooperation and coordination (being isolated at the disaster-stricken area, or running short of resources for the disaster response). The site responder terminal 109 of the user A3 being the site responder receives the attribute information of the user B3 as a cooperation and coordination candidate, and requests cooperation and coordination to a site responder terminal utilized by the user B3 in accordance with the instruction of the user A3. When notification of the cooperation and coordination request acceptance is received from the site responder terminal of the user B3, the site responder terminal of the user A3 registers attribute information of the user B3 into the coordination destination DB 254.

In the analysis and impact determination process flow 303, the information analysis device 108 of the user A2 being the information analyst estimates present situations and developments at the disaster-stricken area, and impacts thereof on the disaster response, from information registered in the collected information DB 255, and the information analysis result registered in the analysis result DB 256, determines whether the analysis result gives an impact on each site responder (for example, user A3), and if an impact is determined, transmits the analysis result to a site responder terminal 109 utilized by the user A3.

In the joint plan creation process flow 304, the decision-making support device 107 of the user A1 being the decision maker calculates the cooperation degree based on the utilization status of disclosed information of the other organization (such as amount of disclosed information of the other organization registered in the collected information DB 255), and data of the coordination destination DB 254 registered in the site coordination destination determination process flow 302, and requests cooperation and coordination to a decision-making support device 107 of the user B1 being the decision maker of the organization (for example, Organization B) with a high cooperation degree. Also, when notification of the cooperation and coordination request acceptance is received from the decision-making support device 107 of the user B1, the decision-making support device 107 of the user A1 supports joint plan generation processing between the user A1 and the user B1 via the site coordination device 103.

Hereinafter, the above support destination determination process flow 301, the site coordination destination determination process flow 302, the analysis and impact determination process flow 303, and the joint plan creation process flow 304 are described in detail respectively. Operations associated with the decision-making support method according to the embodiment described below are implemented by programs executed by each device constituting the decision-making support system 10 by reading into a memory or the like thereof. The programs comprise codes for performing various operations described below.

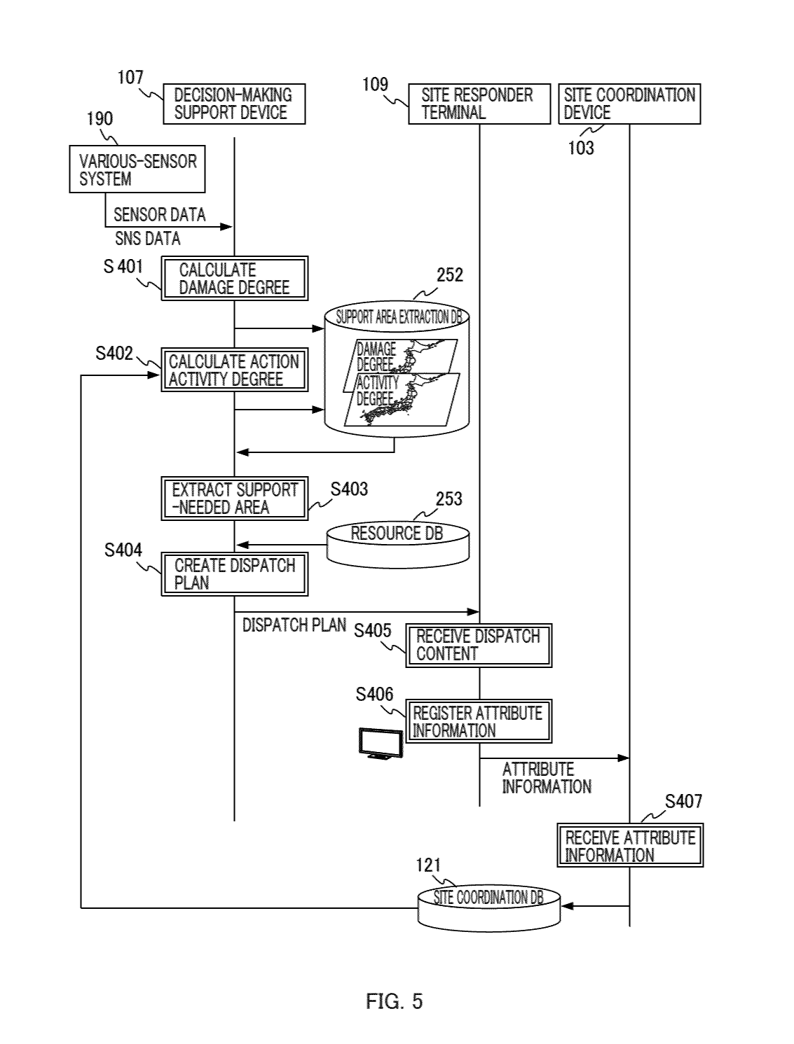

Example of Support Destination Determination Process Flow FIG. 5 is a flowchart showing a process procedure example 1 of the decision-making support method according to the embodiment. Specifically, FIG. 5 illustrates the above support destination determination process flow 301. In this case, the decision-making support device 107 causes the damage degree calculation function 201 to collect, for each of areas forming the disaster-stricken district, each value of the disaster information acquired from various-sensor system 190 and/or site responder terminals 109, namely, information of the collected information DB 255 (such as seismic intensity and damage information), and analysis result of the analysis result DB 256 (such as estimated building damage, estimated human damage, estimated flood, estimated tsunami damage, estimated fire occurrence/fire spread, and estimated life line damage), calculate the damage degree being a value normalized for each areas, and store in the support area extraction DB 252 (S401).

The decision-making support device 107 causes the action activity degree calculation function 202 to perform text analysis, voice analysis, image/video analysis and the like for SNS information on the internet, and news report information of the television, radio, and the like, extract information on the workforce, organization, and movements of vehicles, material, and equipment, calculate the number of pieces of information for each of the above areas, calculate the action activity degree being a value normalized for each of areas, and store in the support area extraction DB 252 (S402).

In step S402, if attribute information of the user (site responder) has been registered in the site coordination DB 121 of the above site coordination device 103, the decision-making support device 107 counts the number of workforce for each of the above areas based on the dispatch destination or the work area (place), and the number of workforce for the disaster response of site responders contained in the attribute information, and uses the number of workforce for calculation of the action activity degree.

Next, the decision-making support device 107 causes the support-needed area extraction function 203 to identify an area with a high damage degree and a low action activity degree, or an area with an extremely high damage degree and an extremely high action activity degree compared with other areas, as the support-needed area, based on the damage degree calculated in the above step S401, and the action activity degree calculated in step S402 (S403).

Then, the decision-making support device 107 causes the dispatch plan creating function 204 to create a disaster response plan comprising the dispatch target user (for example, user B3′ of the site responder), the dispatch destination area, and the operation content (such as information collection and life-saving) for the support-needed area identified in the above step S403, based on information on the place such as the dispatch destination and destination of each user (site responder) in the organization stored in the resource DB 253, and information on name of the parent organization and unit, contact (such as information for access to the site responder terminal 109), the workforce, the retained material and equipment, the present location, the operation content, and the shortage information (such as workforce, material and equipment). Then, the decision-making support device 107 transmits the disaster response plan to a site responder terminal 109 utilized, for example, by the user B3′ of the site responder (S404).

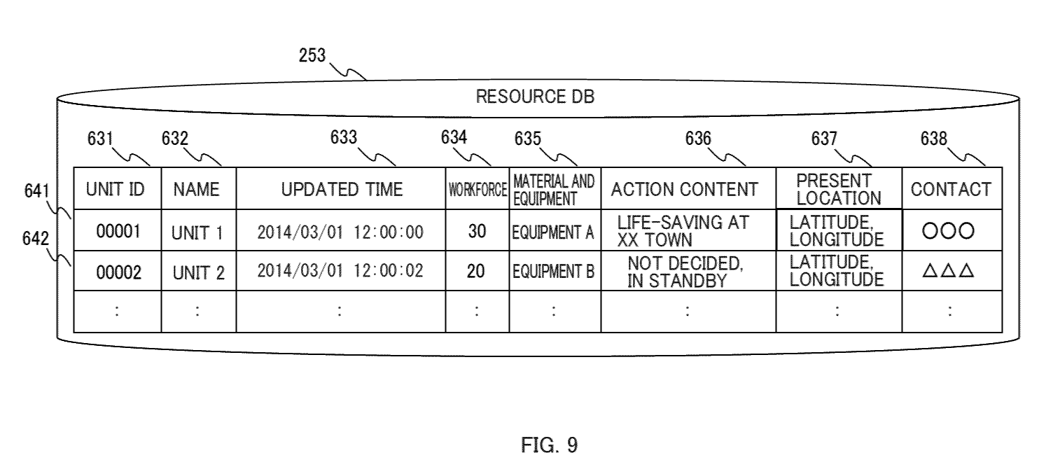

The above resource DB 253 comprises, as illustrated in FIG. 9, a field “Unit ID” 631 for identifying each user and unit (to which multiple users belong), a field “Name” 632 for registering the user name and the unit name, a field “Updated Time” 633 for registering the time when any field of the record is updated, a field “Workforce” 634 for registering the number of workforce of the unit, a field “Material and Equipment” 635 for registering the retained material and equipment, a field “Action Content” 636 for registering the action content, a field “Present Location” 637 for registering the present location, dispatch destination, the destination, and the like, and a field “Contact” 638 for registering the contact (such as information for access to the site responder terminal).

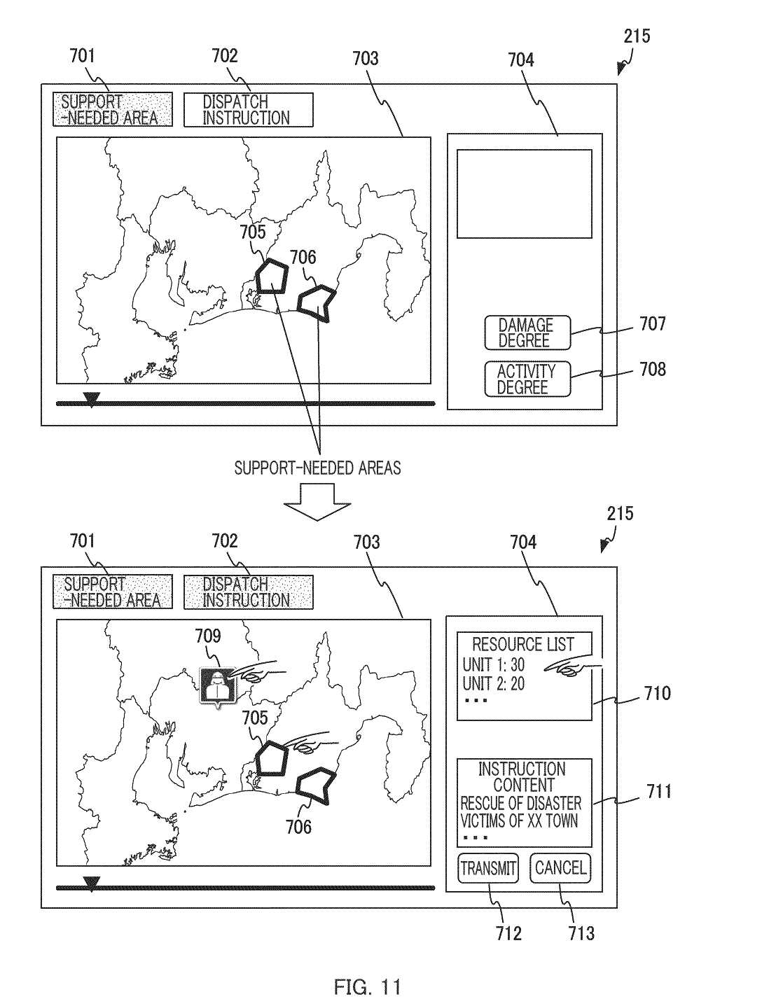

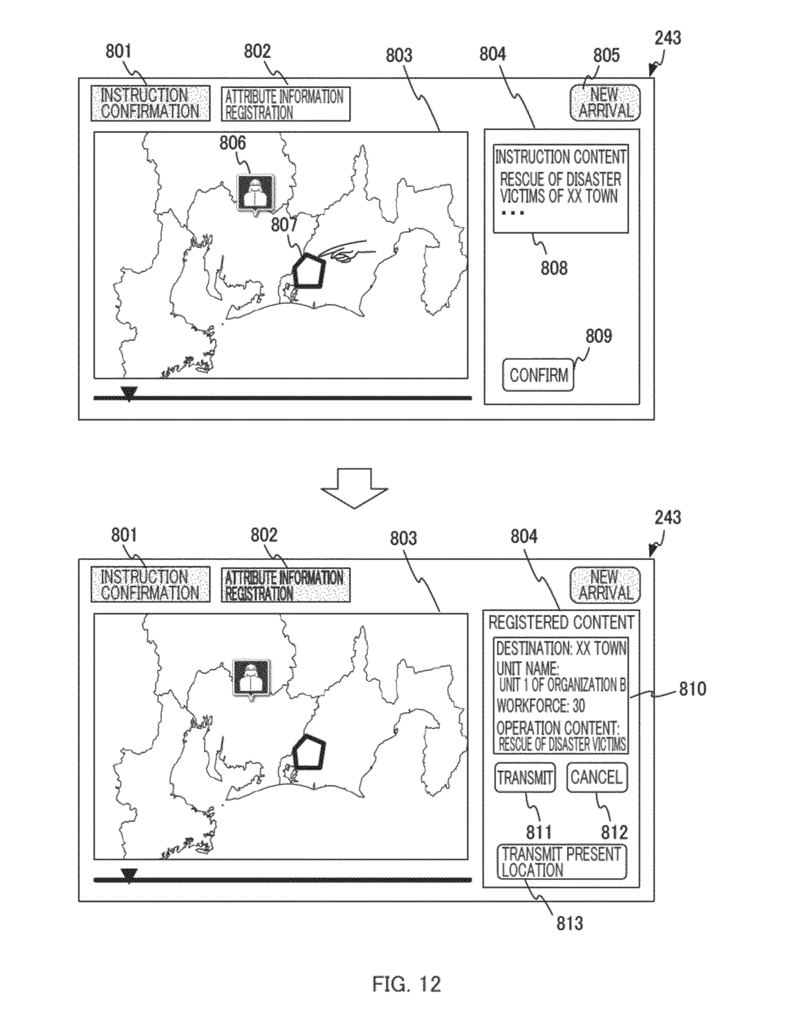

FIG. 11 shows a screen transition example of a screen IF 215 when above steps S401 to S404 are performed. The screen display shown in FIGS. 11 and 12 is just an example. Check boxes, buttons, and display areas forming the screen may be arranged and configured freely. Further, the screen may be divided to multiple sections.

In this case, when the support-needed area button 701 of the screen IF 215 is pressed on an input device of the decision-making support device 107, the decision-making support device 107 displays a support-needed area identified in the above step S403 (for example, 705 and 706) on the situation finding screen 703 by mapping it on the map.

When the damage degree button 707 is pressed in the screen IF 215, the decision-making support device 107 displays the damage degree for each of areas calculated in step S401 on the situation finding screen 703. When the activity degree button 708 is pressed, the decision-making support device 107 displays the action activity degree for each of areas calculated in step S402 on the situation finding screen 703.

Further, when the dispatch instruction button 702 of the screen IF 215 is pressed, the decision-making support device 107 displays information (such as unit name and workforce) 710 of a unit located within a predetermined range from the support-needed area on the information display screen 704, the information 710 being acquired from the resource DB 253, and based on the location thereof, displays a symbol 709 (such as an icon that the decision-making support device retains in advance) indicating the unit on the situation finding screen 703.

When the unit information 710 displayed on the information display screen 704 or the symbol 709 displayed on the situation finding screen 703 is pressed, and further, the dispatch area (for example, support-needed area 705) selected out of support-needed areas by a decision maker or the like through an input device is pressed, the decision-making support device 107 displays the instruction content entry screen 711, and accepts entry of the instruction content by the decision-maker or the like on the screen. In response to pressing of the transmission button 712, the decision-making support device 107 generates, as shown in the above step S404, a disaster response plan comprising the dispatch target user (for example, user B3′ of the site responder), the dispatch destination area, and the operation content (such as information collection and life-saving), and transmits the disaster response plan, for example, to a site responder terminal 109 utilized by the user B3′ of the site responder.

Here, description is made back to the process flow. On the other hand, the site responder terminal 109 causes the instruction content management function 231 to receive the disaster response plan (such as the dispatch destination area and the operation content (such as information collection and life-saving)) transmitted from the decision-making support device 107, and acquires information (such as a map and damage situations of dispatch destination) necessary for the relevant operation from the map DB 251 and the collected information DB 255 of the data management device 110 (S405).

Next, the site responder terminal 109 causes the attribute information registration function 232 to transmit attribute information based on the disaster response plan received in the above step S405 to the site coordination device 103, the attribute information including location-related information such as the dispatch destination area, and operation content (such as information collection and life-saving), and information of the organization to which a user (for example, user B3′ of the site responder) registered in the resource DB 253 belongs, such as the unit name, the contact (such as information for access to the site responder terminal 109 utilized by the user B3′ of the site responder), the workforce, the retailed material and equipment, the present location (acquired by direct input or GPS), and the shortage information (direct input of workforce, material and equipment) (S406).

On the other hand, the site coordination device 103 causes the attribute information management unit 116 to receive attribute information transmitted in the above step S406 from the site responder terminal 109 utilized by the user B3′ of the above site responder, and register the attribute information into the site coordination DB 121 (S407).

FIG. 12 shows a screen transition example of the screen IF 243 during the execution of the above steps S405 to S406. The site responder terminal 109 displays the symbol 806 at a corresponding place on the situation finding screen 803 of the screen IF 243 based on, for example, the value of the present location of the user's parent unit acquired from the resource DB 253 (the value may be acquired from the GPS).

Upon receiving the disaster response plan (the dispatch destination area and the operation content (such as information collection and life-saving)) from the decision-making support device 107, the site responder terminal 109 causes the new arrival button 805 of the screen IF 243 to turn on. Here, when the site responder presses the new arrival button 805 through an input device, the site responder terminal 109 displays a dispatch destination area (for example, area 807) indicated by the disaster response plan on the situation finding screen 803. When the dispatch destination area 807 is pressed, the site responder terminal 109 displays the operation content (such as information collection, and life-saving) indicated by the above disaster response plan at the instruction content display area 808 of the information display screen 804. Further, when the confirmation button 809 is pressed, the site responder terminal 109 notifies, for example, the decision-making support device 107 that the disaster response plan has been confirmed.

When the attribute information registration button 802 is pressed on the above screen IF 243, the site responder terminal 109 displays information on the registered content display screen 810 of the information display screen 804 based on the disaster response plan received from the decision-making support device 107, the information including information on the place such as the dispatch destination area and the operation content (such as information collection and life-saving), and information of the parent organization of the user registered in the resource DB 253 such as the unit name, the contact, the number of workforce, the retained material and equipment, and the present location (acquired by direct input or GPS). Here, when the transmission button 811 is pressed, the site responder terminal 109 transmits information displayed on the registered content display screen 810 to the site coordination device 103 as attribute information. The site responder terminal 109 may include shortage information (such as the workforce and material and equipment) from the site responder in the above attribute information by receiving input thereof on the registered content display screen 810. When the present location transmission button 813 is pressed, the site responder terminal 109 transmits information on the present location (such as latitude, longitude, altitude, and time) acquired by GPS or the like to the site coordination device 103.

Example of Support-Needed Area Extraction Process Flow

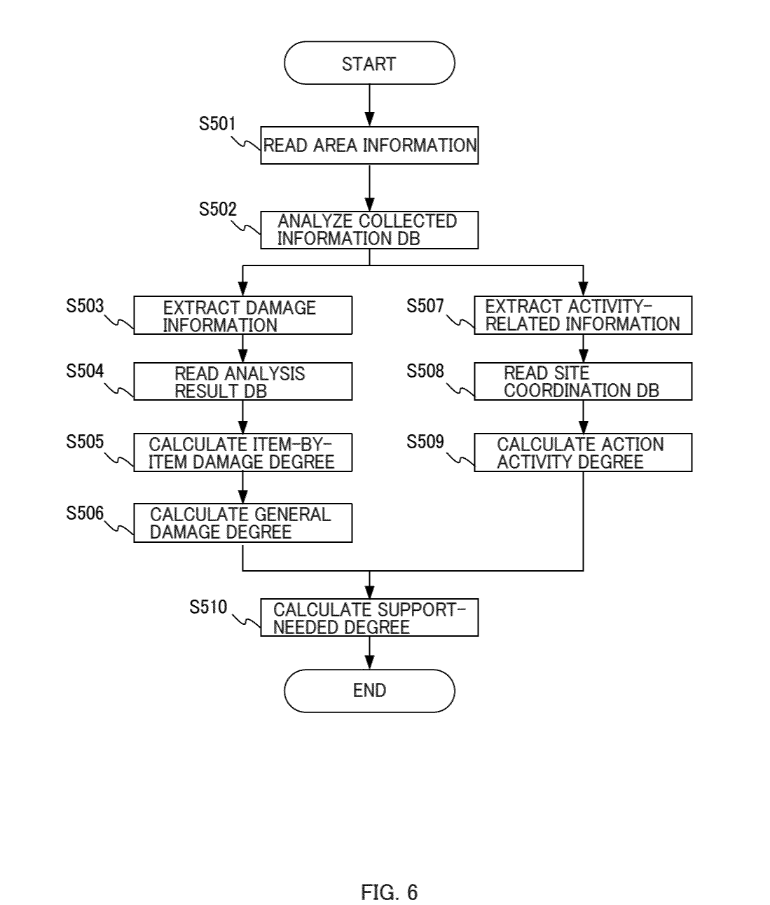

FIG. 6 is a flowchart showing a procedure example 2 of the decision-making support method according to the embodiment. Specifically, FIG. 6 illustrates the support-needed area extraction process flow in the above steps S401 to S403. In this case, in step S501, the decision-making support device 107 acquires information of each area (such as identification block ID, latitude and longitude range) from the map DB 251.

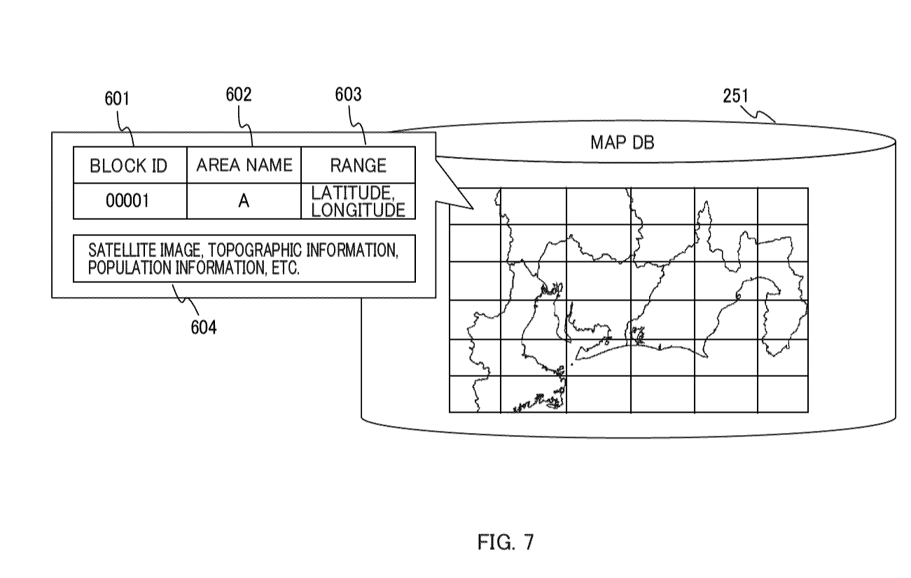

The map DB 251 is a database storing map data and satellite image, and information such as topographic information, building information, and population information, as shown in FIG. 7. The database comprises a field “Block ID” 601 for storing the block ID to identify the above area, a field “Area Name” 602 for storing the name of the corresponding area, a field “Range” 603 for storing the range (latitude and longitude range) of the area, and a field 604 for storing the satellite image, topographic information, building information, population information, and the like of the area. The latitude and longitude range in the map DB 251 may be changed by the user. That is, information of multiple areas containing differently divided areas by different users may be registered.

Then, in step S502, the decision-making support device 107 performs text analysis, voice analysis, image and video analysis, and the like for each record in the collected information DB 255 that stores disaster information acquired from various-sensor system 190 and/or the site responder terminal 109, and extracts damage-related records (such as seismic intensity information and damage information) as well as records relating to the workforce, the organization, and movements of vehicles, and material and equipment (for example, a record with the field “Content” containing information such as a fire engine discharging water, and a policeman guiding evacuation).

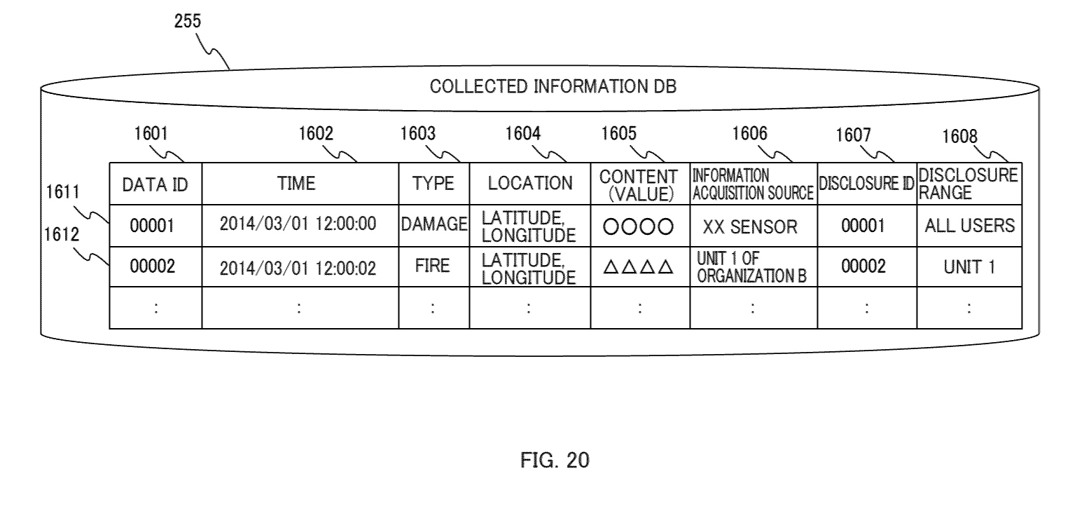

Next, in step S503, the decision-making support device 107 extracts “Content (value)” of a record relating to the type “Damage” extracted in step S502 for each of areas or for each value of the field “Location” acquired in the above step S501. A specific data configuration example of the collected information DB 255 (FIG. 20) is described later.

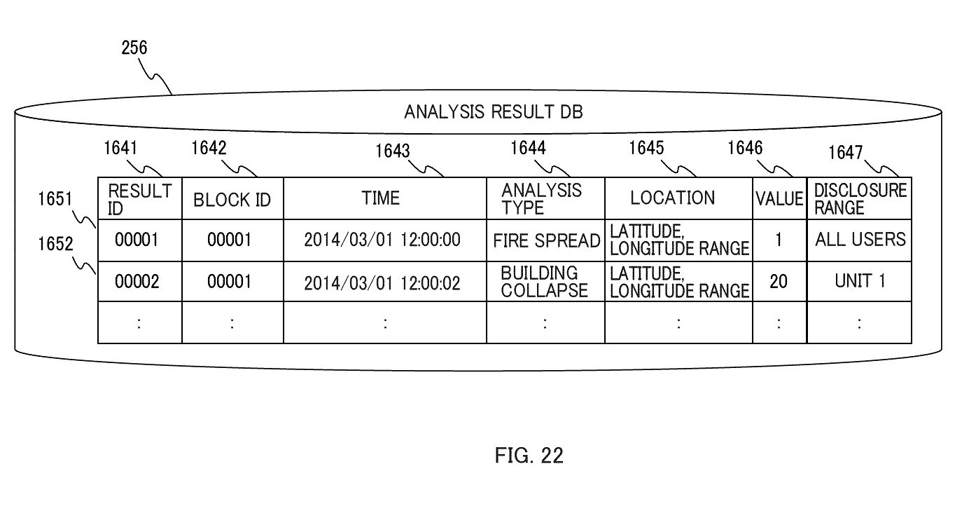

Then, in step S504, the decision-making support device 107 extracts records of the analysis result (such as estimated building damage, estimated human damage, estimated flood damage, estimated tsunami damage, estimated fire outbreak/fire spread, and estimated life line damage) from the analysis result DB 256, and classifies the records for each of areas acquired in the above step S501. A specific data configuration example of the analysis result DB 256 (FIG. 22) is described later.

Next, in step S505, the decision-making support device 107 calculates the item-by-item damage degree based on values of records classified for each of areas in the above steps S503 and S504. For example, for records relating to the seismic intensity information (for example, records containing “Seismic Intensity” in the field “Type”) in the collected information DB 255, when the value in the field “Content” of a record classified as an area with the block ID=1 is “5” (but, if two or more records are classified, for example, an average of values in the field “Content” is used), the value in the field “Content” of a record classified as an area with the block ID=2 is “4”, and the value in the field of “Content” of a record classified as an area with the block ID=3 is “6”, the item-by-item damage degree relating to the field “Seismic Intensity” is, for example, “1” relatively with the damage degree of an area with the block ID=1 as a reference value, and as a difference from the reference value, the damage degree of an area with the block ID=2 is “0”, and the damage degree of an area with the block ID=3 is “2”. Similarly, the decision-making support device 107 calculates the item-by-item damage degree for each of areas based on the field “Analysis Type” and the field “Value” regarding the analysis result of the analysis result DB 256.

Then, in step S506, the decision-making support device 107 calculates the general damage degree for each of areas by adding up item-by-item damage degrees calculated in the above step S505 to the damage degree for each of areas. For example, when the item-by-item damage degree relating to the field “Seismic Intensity” is, for example, “1” for an area with the block ID=1, “0” for an area with the block ID=2, and “2” for an area with the block ID=3, and the item-by-item damage degree relating to the field “Tsunami Damage” is “0” for the area with the block ID=1, “2” for the area with the block ID=2, and “7” for the area with the block ID=3, the general damage degree for each area is “1” for the area with the block ID=1, “2” for the area with the block ID=2, and “9” for the area with the block ID=3.

Next, in step S507, the decision-making support device 107 extracts information on the workforce, the organization and the movement of vehicles, material and equipment for each of areas acquired in the above step S501, based on the value of the field “Location” out of records relating to the workforce, the organization, and the movement of vehicles, material and equipment extracted in step S502.

Then, in step S508, the decision-making support device 107 calculates the number of workforce for each of areas acquired in the above step S501, based on values of the field “Present Location, and the field “Number of Workforce” of each record registered in the site coordination DB 121 of the above site coordination device 103.

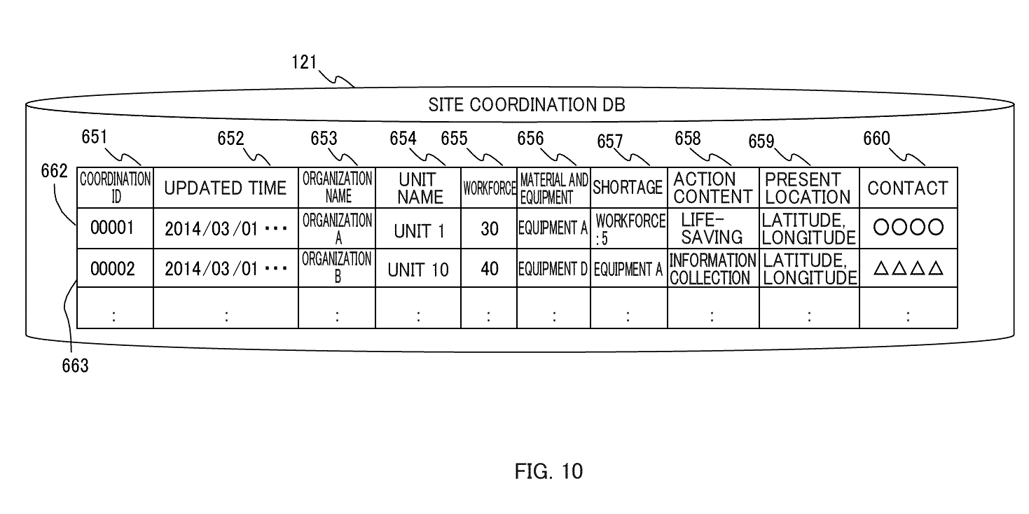

The above site coordination DB 121 comprises, as illustrated in FIG. 10, a field “Coordination ID” 651 for identifying records 662, 663, . . . , a field “Updated Time” 652 for registering the time when a record is added or updated, and, for example, as information of the attribute information of the user received in step S407, a field “Organization Name” 653 for registering the organization name, a field “Unit Name” 654 for registering the user name and the unit name, a field “Workforce” 655 for registering the workforce, a field “Material and Equipment” 656 for registering the retained material and equipment, a field “Shortage” 657 for registering information on the shortage of the workforce, material and equipment, a field “Action Content” 658 for registering the action content and the operation content, a field “Present Location” 659 for registering the present location, destination, and the like, and a field “Contact” 660 for registering the contact (information for access to the site responder terminal).

Then, in step S509, the decision-making support device 107 calculates the action activity degree for each of areas from the number of records classified for each of areas in the above step S507, and the number of workforce calculated in step S508.

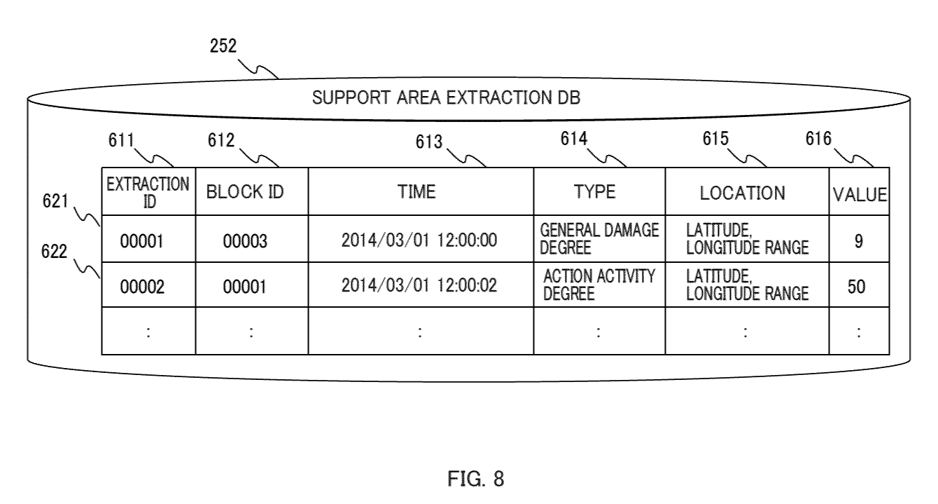

Values of the general damage degree and the action activity degree thus calculated are stored into the support area extraction DB 252 by the decision-making support device 107. The support area extraction DB 252 comprises, as illustrated in FIG. 8, afield “Extraction ID” 611 for identifying each record, a field “Block ID” 612 for registering the block ID for identifying the area, a field “Time” 613 for registering the time when a record is registered or updated, a field “Type” 614 for registering the field name such as the damage degree, action activity degree, or item-by-item damage degree, a field “Location” 615 for registering the range (latitude and longitude range) of the area, and a field “Value” 616 for registering the value of the damage degree and the action activity degree. For example, the general damage degree of the area with the block ID=3 calculated in the above step S506 is registered like the record 621.

Finally in step S510, the decision-making support device 107 identifies an area with a high damage degree and a low action activity degree, or an area with an extremely high damage degree or an extremely high action activity degree compared with other areas, as the support-needed area (an area to which the unit should be dispatched), based on the general damage degree calculated in the above step S506, and the action activity degree calculated in step S509. For example, when the general damage degree of each of areas is “1” for the area with the block ID=1, “2” for the area with the block ID=2, and “9” for the area with the block ID=3, and the action activity degree for each of areas is “10” for the area with the block ID=1, “2” for the area with the block ID=2, and “1” for the area with the block ID=3, the area with the block ID=1, and the area with the block ID=3 are extracted.

When disaster's scale is large, and there is a need to respond to the disaster with cooperation of multiple organizations, this process flow enables a remote support organization not clearly knowing the need of the disaster-stricken site to dispatch a support unit to the disaster-stricken site by determining an area to be supported, at their discretion, and support autonomous and smooth intervention to the response activity in the disaster-stricken area from the outside thereof.

Example of Site Coordination Destination Determination Process Flow

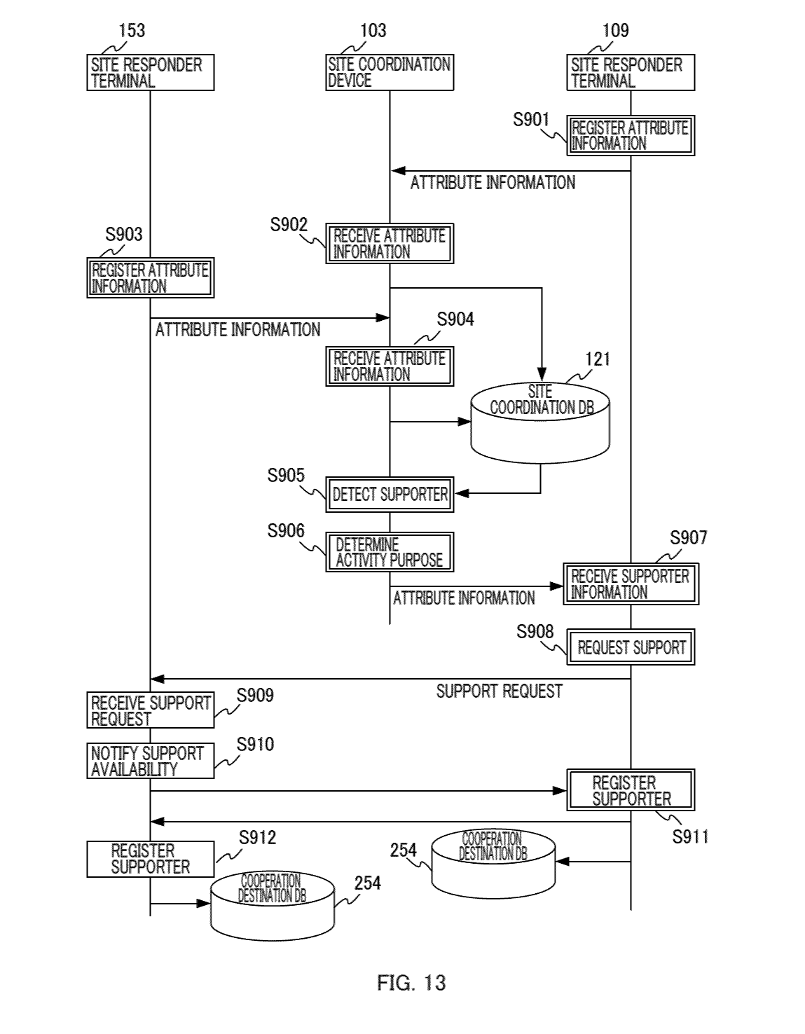

Next, a detail of the site coordination destination determination process flow 302 is described. FIG. 13 is a flowchart showing a procedure example 3 of the decision-making support method according to the embodiment. Specifically, FIG. 13 illustrates the site coordination destination determination process flow 302. In this case, the site responder terminal 109 utilized by the user A3 of the site responder transmits attribute information to the site coordination device 103, the attribute information including information registered in the resource DB 253 of the data management device 110 such as the organization to which the user A3 belongs, the unit name, the contact (such as information for access to the site responder terminal 109 utilized by the user A3), the number of workforce, and the retained material and equipment, and information on the present location (acquired by direct input or by GPS), the shortage information (shortage of the workforce and material and equipment entered by the user A3 through an input device), the dispatch destination for disaster response, and the operation content (such as information collection, and life-saving) (S901).

Here, the timing of transmitting the attribute information is a periodical timing, a time designated by the user A3, or a timing requested by the site coordination device 103. The content of the transmitted attribute information may be only a difference (for example, information of the present location) from attribute information transmitted last time. Upon detecting the difference, the site responder terminal 109 updates information (for example, the present location) corresponding to the difference out of the attribute information of the user A3 registered in the resource DB 253, with a new value.

Then, the site coordination device 103 causes the attribute information management unit 116 to receive the attribute information transmitted in the above step S901 from the site responder terminal 109 utilized by the user A3 of the site responder, and register the attribute information into the site coordination DB 121 (S902). Here, if the record relating to the attribute information of the site responding user A3 has been registered into the site coordination DB 121, the present time is overwritten in the field “Updated Time” of the record, and other fields are also overwritten with corresponding field values of the above received attribute information.

Next, the site responder terminal 153 utilized by the user B3 of the site responder transmits attribute information to the site coordination device 103, the attribute information including information registered in the resource DB 253 of the data management device 154 such as the name of the organization and the unit to which the user B3 belongs, the contact (such as information for access to the site responder terminal utilized by the user B3 of the site responder), the number of workforce, and the retained material and equipment, and information such as the present location (acquired by direct input of the user B3 or by GPS), the shortage information (information entered by the user B3 through an input device), the dispatch destination, and the operation content (such as information collection and life-saving) (S903). Timing of transmitting the attribute information and operation of transmitting the difference of the attribute information are same as the case of the site responder terminal 109 shown in the above step S901.

On the other hand, the site coordination device 103 causes the attribute information management unit 116 to receive the attribute information transmitted in the above step S903 from the site responder terminal 153 utilized by the user B3 of the site responder, and register the attribute information in the site coordination DB 121 (S904). Here, if a record relating to the attribute information of the site responding user B3 has been registered in the site coordination DB 121, the site coordination device 103 overwrites the present time in the field “Updated Time” of the record, and also overwrites other fields with corresponding values of the received attribute information.

The site coordination device 103 causes the supporter detection unit 118 to detect a user of the other organization located within the activity range (within a predetermined distance from the present location) of users whose attribute information is registered in the site coordination DB 121 (S905). For example, in the case of the user A3 whose attribute information is registered in the site coordination DB 121 in the above step S902, if a distance calculated from present location information contained in the attribute information of the user B3 registered in step S904, and present location information contained in the attribute information of the user A3 registered in the site coordination DB 121 is within a predetermined range, the user B3 is detected as a user located within the activity range of the user A3.

Next, the site coordination device 103 causes the activity purpose determination unit 119 to determine the consistency between attribute information of each user whose attribute information is registered in the site coordination DB 121, and the attribute information of users of the other organization detected in the above step S905, extract a user suitable for cooperation and coordination out of users of the other organization detected in step S905, and notify the attribute information of the user to the site responder terminal of each user (S906).

For example, in the case of the user A3 whose attribute information is registered in the site coordination DB 121, if the operation content out of the information of the operation content and the retained material and equipment contained in the attribute information of the user B3 detected in step S905 is identical or similar to the operation content contained in the attribute information of the user A3, or if the retained material and equipment contained in the attribute information of the user B3 is identical or similar to the shortage information (material and equipment) of the user A3, the attribute information of the user B3 is transmitted to the site responder terminal 109 utilized by the user A3, and the user B3 is notified as a user suitable for the cooperation and coordination, or as the cooperation and coordination candidate.

On the other hand, the site responder terminal 109 utilized by the user A3 of the site responder causes the support request/support availability notification function 233 to receive attribute information of the user B3 being the cooperation and coordination candidate notified by the site coordination device 103 in the above step S906 (S907), and transmit a cooperation and coordination request containing the attribute information of the user A3 to the site responder terminal 153 utilized by the user B3 (S908).

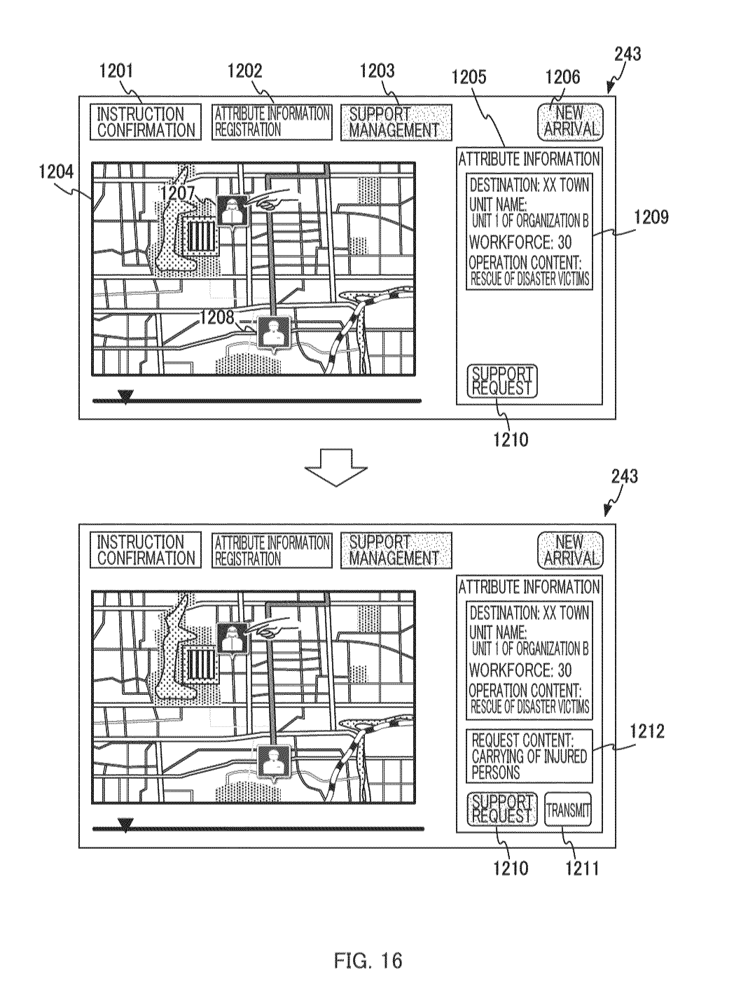

Here, a screen transition of the screen IF 243 during the execution of the above steps S907 and S908 is shown. FIG. 16 is a transition example 3 of the display screen according to the embodiment. Specifically, FIG. 16 is a screen transition example of the screen IF 243 when the above steps S907 and S908 are executed. The screen display shown in FIG. 16 is just an example. Check boxes, buttons, and display areas forming the screen may be arranged and configured freely. Further, the screen may be divided into multiple sections.

If there exists a unit of the other already coordinating organization when pressing of the support management button 1203 is detected on the screen IF 243, the site responder terminal 109 causes a symbol 1208 of the unit of the other already cooperating and coordinating organization to be displayed on a map of the situation finding screen 1204 based on information registered in the site coordination DB 121.

Upon receiving attribute information of the site responder being the cooperation and coordination candidate from the site coordination device 103, the site responder terminal 109 causes the new arrival button 1206 to turn on, and when the new arrival button 1206 is pressed, displays a symbol 1207 of the site responder being the cooperation and coordination candidate on the situation finding screen 1204. When the symbol 1207 is selected, the site responder terminal 109 displays attribute information of a site responder corresponding to the selected symbol 1207 on the attribute information display screen 1209 of the information display screen 1205. Here, when a support request button 1210 is pressed, the site responder terminal 109 displays a request content input screen 1212, and receives input of the request content by the site responder. Here, when the transmission button 1211 is pressed, the site responder terminal 109 transmits a cooperation and coordination request to a site responder terminal utilized by the site responder of the cooperation and coordination candidate.

Here, description is made back to the process flow. On the other hand, the site responder terminal 153 utilized by the user B3 of the site responder causes the support request/support availability notification function 233 to receive a cooperation and coordination request including the attribute information of the user A3 from a site responder terminal 109 utilized by the above user A3 (S909), and transmit a response as to the cooperation and coordination availability entered by the user B3 through an input device, and, if the coordination is available, the attribute information of the user B3 to a site responder terminal 109 of the cooperation and coordination request transmission source (user A3) (S910).

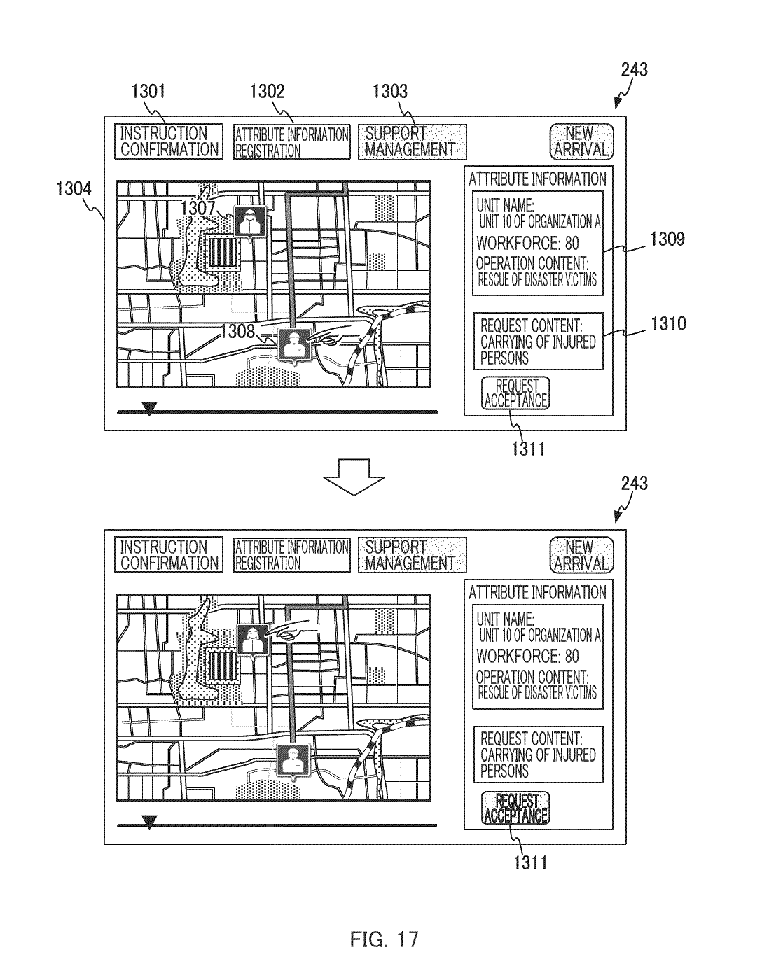

A screen transition example of the screen IF 243 during the execution of such steps S909 and S910 is as illustrated in FIG. 17. The screen display shown in FIG. 17 is just an example. Check boxes, buttons, and display areas forming the screen may be arranged and configured freely. Further, the screen may be divided into multiple sections.

In this case, if there exists a unit of the other already coordinating organization when a support management button 1303 is pressed on the screen IF 243, the site responder terminal 153 causes a symbol 1308 of the unit of the other already coordinating organization to be displayed on a map of the situation finding screen 1304 based on the information registered in the site coordination DB 121.

Upon receiving the cooperation and coordination request from a site responder terminal 109 utilized by a user of the other organization, the site responder terminal 153 causes the new arrival button 1306 to turn on. When the new arrival button 1306 is pressed, the site responder terminal 153 displays a symbol 1308 of a site responder of the cooperation and coordination request transmission source on the situation finding screen 1304. When the symbol 1308 is selected, the site responder terminal 153 causes attribute information of a site responder corresponding to the selected symbol 1308 to be displayed on the attribute information display screen 1309 of the information display screen 1305, and displays the content of the cooperation and coordination request on the request content display screen 1310. Here, when a request acceptance button 1311 is pressed, the site responder terminal 153 notifies a request acceptance to a site responder terminal 109 utilized by the site responder of the cooperation and coordination request transmission source.

Here, description is made back to the process flow. The site responder terminal 109 utilized by the user A3 of the site responder causes the supporter registration function 234 to receive a response as to the cooperation and coordination availability from the site responder terminal 153 utilized by the above user B3, and if the response indicates acceptance of the cooperation and coordination, register attribute information of the user B3 included in the response in the cooperation destination DB 254. Then, the site responder terminal 109 notifies the site responder terminal 153 of the user B3 that the attribute information has been registered (S911).

Upon receiving the notification from the site responder terminal 109 of the user A3 by the supporter registration function 234 that the attribute information has been registered in the coordination destination DB 254, the site responder terminal 153 utilized by the user B3 of the site responder registers the attribute information of the user A3 included in the notification to the coordination destination DB 254 (S912).

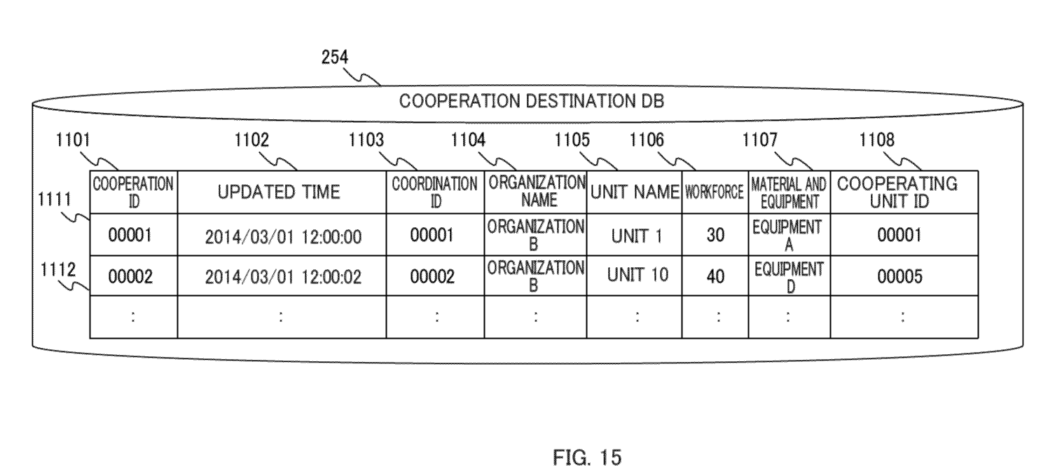

The above cooperation destination DB 254 includes a data configuration illustrated in FIG. 15. FIG. 15 is a configuration example of the cooperation destination DB 254 according to the embodiment. The cooperation destination DB 254 illustrated herein comprises a filed “Cooperation ID” 1101 for identifying each record, a field “Time” 1102 for registering the time when a record is registered or updated, a field “Coordination ID” 1103 for registering the coordination ID for identifying a record when the attribute information of the user received in the above steps S911 and S912 is also registered in the site coordination DB 121, a filed “Organization Name” 1104 for registering the organization name, a field “Unit Name” 1105 for registering the user name or the unit name, a field “Workforce” 1106 for registering the number of workforce, a field “Material and Equipment” 1107 for registering the material and equipment, and a field “Cooperation Unit ID” for registering the unit ID (identification number assigned in the resource DB 253) of a unit cooperating with a unit of the record registered in the cooperation destination DB 254. For example, the record 1111 indicates that a user of the other cooperating organization is “Unit 1” of “Organization B”, and a unit cooperating with the user is “Unit 1” of the own organization from the record 641 of FIG. 7.

Example of Supporter Detection Process Flow

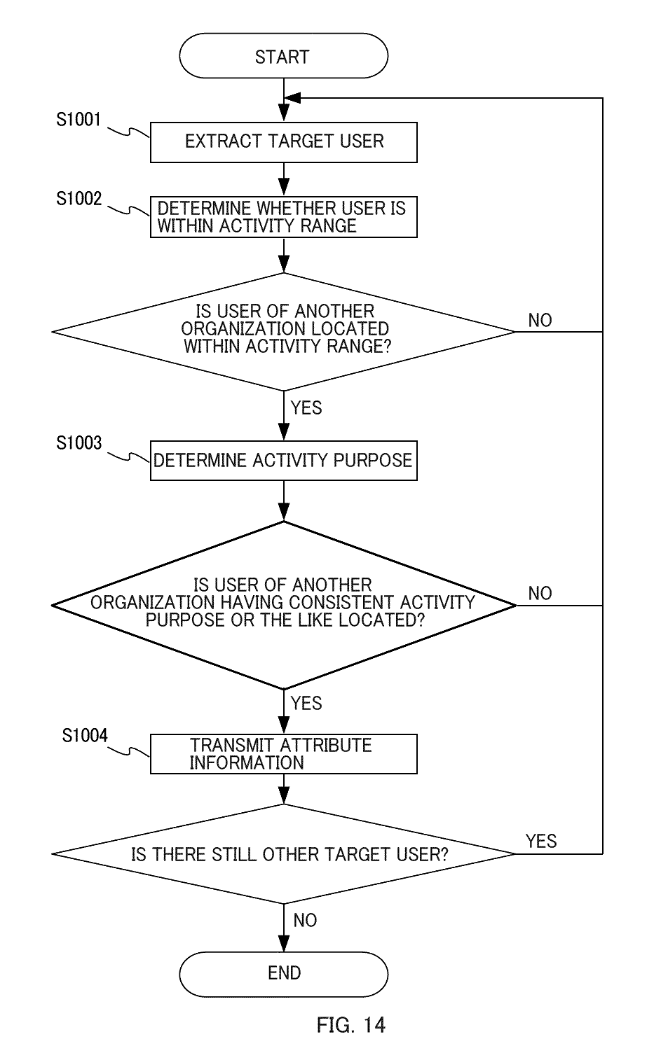

Then, the supporter detection process flow in the above steps S905 and S906 is described in detail. FIG. 14 is a flowchart showing a procedure example 4 of the decision-making support method according to the embodiment. Specifically, FIG. 14 illustrates the supporter detection process flow in the steps S905 and S906.

In this case, in step S1001, the site coordination device 103 extracts one record (for example, record of coordination ID=00001) out of records registered in the site coordination DB 121.

In step S1002, the site coordination device 103 extracts, out of records extracted in the above step S1001, a record containing the present location information in the field “Present Location” indicating the present location that is within a predetermined range of the distance calculated from the present location information thereof and the present location information contained in the field “Present Location” of other records. Here, if there is no record to be extracted, the site coordination device 103 determines that no user of the other organization exists within the activity range of the user corresponding to the record with coordination ID=00001, and performs processing of the above step S1001 for records excluding the record with coordination ID=00001. When there are two or more records to be extracted, the site coordination device 103 performs step S1003.

In step S1003, the site coordination device 103 determines the consistency between the value in each field of the record (for example, a record with coordination ID=00001) extracted in the above step S1001, and the value in each field of the record extracted in step S1002. For example, if the operation content contained in the record extracted in step S1002 is identical or similar to the operation content contained in the record with the coordination ID=00001, or if material and equipment of retained material and equipment information, and material and equipment indicated in the shortage information (material and equipment) contained in the above records are identical or similar to each other, the records are extracted as records having a consistent active purpose. Here, if there is no record to be extracted, the site coordination device 103 determines that there exists no user of the other organization consistent with the activity purpose of the user corresponding to the record with the coordination ID=00001, and performs processing of step S1001 for records other than the record with the coordination ID=00001. If there are two or more records to be extracted, the site coordination device 103 performs step S1004.

Then, in step S1004, the site coordination device 103 transmits values of the record extracted in the above step S1003 as the attribute information of the user being the cooperation and coordination candidate to a site responder terminal of the user corresponding to the record with the coordination ID=00001 based on the field “Contact” of the record (for example, the record with the coordination ID=00001) extracted in step S1001.

Here, if, out of records registered in the site coordination DB 121, there is any record not subjected to the above steps S1002 to S1104, the site coordination device 103 determines that there still remains a target user, and performs the above step S1001 for the record.

The process flow described above enables site responders, or both of the supporter and the supportee to perform cooperative operation promptly at the disaster-stricken area without waiting for determination of the decision maker, and thereby enables prompt and efficient rescue of disaster victims at the disaster-stricken area.

Example of Analysis and Impact Determination Process Flow

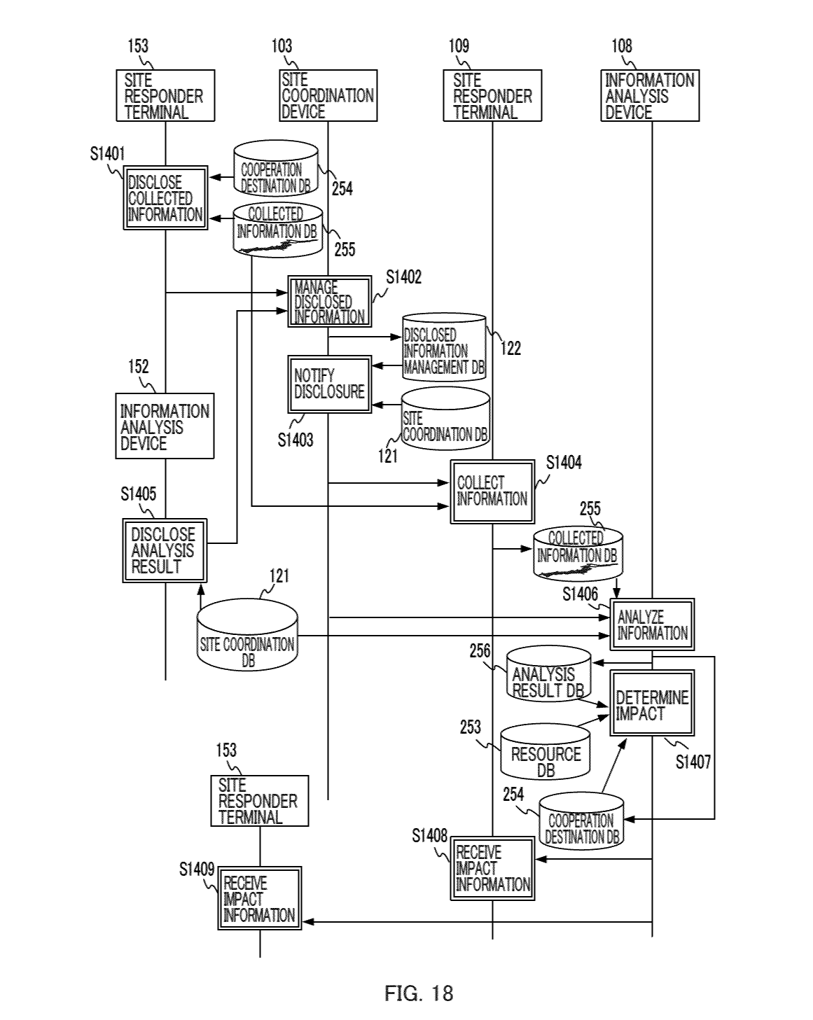

Next, the above analysis and impact determination process flow 303 is described. FIG. 18 is a flowchart showing a procedure example 5 of the decision-making support method according to the embodiment. Specifically, FIG. 18 illustrates the analysis and impact determination process flow.

In this case, the site responder terminal 153 utilized by the user B3 of the site responder causes the information disclosure function 242 to accept designation of a user (of the other organization) authorized to access to each information registered in the collected information DB 255 from the site responder through an input device, and register the designation into the field “Disclosure Range” of the corresponding record. Information on the user authorized to access may be acquired from the cooperation destination DB 254. The site responder terminal 153 transmits information to be disclosed out of information registered in the collected information DB 255, or information (such as URL) necessary for access to the information to be disclosed, to the site coordination device 103 of the user along with information on the above user authorized to access (for example, the unit name of the user A3) (S1401). The user authorized to access may be designated with the location range, such as a user of the other organization within a predetermined longitude and latitude range from the location of the above user B3. Also, all users may be designated as authorized to access.

A specific data configuration of the above collected information DB 255 is shown in FIG. 20. The collected information DB 255 comprises a field “Data ID” 1601 for identifying each record, a field “Time” 1602 for registering the time when a record is registered or updated, a field “Type” 1603 for registering the summary of information (for example, such as “seismic intensity” and “human damage”), a field “Location” 1604 for entering the location, a field “Content” 1605 for registering the content of information, a field “Information Acquisition Source” 1606 for registering the acquisition source of collected information (information of disclosure source of sensor information, or disclosure information acquired in step S1404 described later), a field “Disclosure ID” 1607 for registering the disclosure ID (assigned by the disclosed information management DB 122) for identifying disclosure information disclosed in or acquired from the site coordination device 103, and a field “Disclosure Range” 1608 for registering information of the user authorized to access to the record.

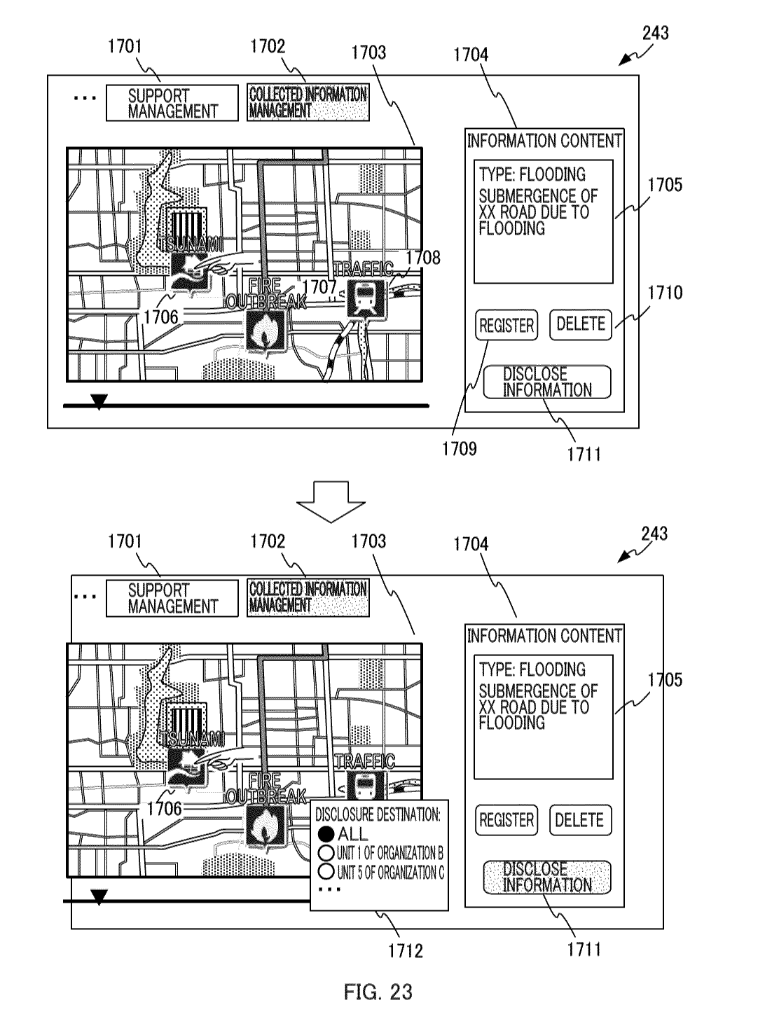

A display screen transition example of the screen IF 243 during execution of the above step S1401 is shown in FIG. 23. The screen display shown in FIG. 23 is just an example. Check boxes, buttons, and display areas forming the screen may be arranged and configured freely. Further, the screen may be divided into multiple sections.

When the collected information management button 1702 is pressed on the screen IF 243 illustrated in FIG. 23, the site responder terminal 153 displays information registered in the collected information DB 255 on the situation finding screen 1703 (for example, symbols 1707 and 1708). Here, when the user B3 of the site responder acquires, for example, information on the flood damage as new information, the user B3 presses a location corresponding to the flooded area on a map of the above situation finding screen 1703. When such new information is selected on the screen IF 243, the site responder terminal 153 causes the information display screen 1704 to display an information input screen 1705.

On the other hand, the above user B3 enters information on “Flood Damage” onto the information input screen 1705, and presses the registration button 1709. On the other hand, the site responder terminal 153 registers information entered by the user B3 on the information input screen 1705 into the collected information DB 255. At that time, the site responder terminal 153 may register a symbol (for example, the symbol 1706) used for displaying newly registered information on the situation finding screen 1703, as well.

Next, assume that the above user B3 presses the above symbol 1706 displayed on the situation finding screen 1703. Then, the site responder terminal 153 causes the content of information on an event selected by the user B3 by pressing the symbol 1706 to be displayed on the information display screen 1704. When the user B3 presses the information disclosure button 1711, the site responder terminal 153 responds by displaying a screen 1712 for entering the disclosure destination, receives from the user B3 a designation for the user (range thereof) of the other organization authorized to access, registers the designation in the collected information DB 255, and transmits to the site coordination device 103.

Here, description is made back to the process flow. Then, the site coordination device 103 causes the disclosed information management unit 117 to receive disclosed information transmitted from the site responder terminal 153 in the above step S1401, or link destination information for access to the disclosed information and information on the user authorized to access, and registers such information in the disclosed information management DB 122 (S1402).

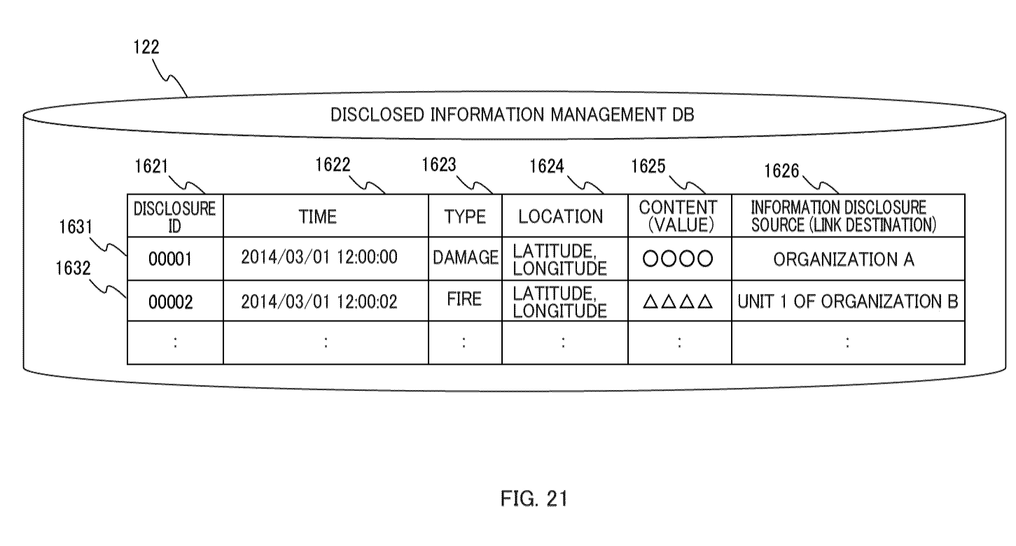

The disclosed information management DB 122 comprises, as illustrated in FIG. 21, a field “Disclosure ID” 1621 for identifying each record, a field “Time” 1622 for registering the time when the record is registered or updated, a field “Type” 1623 for registering the summary of information (for example, such as “seismic intensity” and “human damage”), a field “Location” 1624 for registering the place, a field “Content” 1625 for registering the content of information, and a field “Information Disclosure Source” 1626 for registering the information disclosure source or the link to the information.

When the unit name of “User A3” is indicated, for example, as user information authorized to access to disclosed information newly registered in the disclosed information management DB 122, the site coordination device 103 searches the site coordination DB 121 to identify a record containing “User A3” as the value of the field “Unit Name”, and based on the information registered in the field “Contact etc.” of the corresponding record, notifies the site responder terminal 109 utilized by “User A3” that “Disclosed information to which the user A3 can access has been registered” (S1403). This notification may contain accessible disclosed information or link destination information for access to disclosed information.

If the user authorized to access is designated with the location range such as a user of the other organization located within a predetermined longitude and latitude range from the location of the above user B3 being the registrant of the disclosed information, the site coordination device 103 searches the site coordination DB 121 to extract a record containing the value of the field “Present Location” being within the range designated by the user B3, and based on the information registered in the field “Contact etc.” of the record, notifies the site responder terminal 109 of the above user A3 that accessible disclosed information has been registered.

On the other hand, the site responder terminal 109 utilized by the user A3 being the above site responder causes the information collection function 241 to receive a notification from the site coordination device 103 that disclosed information the user A3 can access has been disclosed by the other organization (for example, user B3), acquire text information, location information, time information, voice information, image, video image or the like from the disclosed information management DB 122 of the site coordination device 103 or the collected information DB 255 of the decision-making coordination system 102 utilized by the user B3, and register into the collected information DB 255 of the data management device 110 in the decision-making coordination system 101 of the own organization together with the information on the user B3 who is an information discloser (S1404)

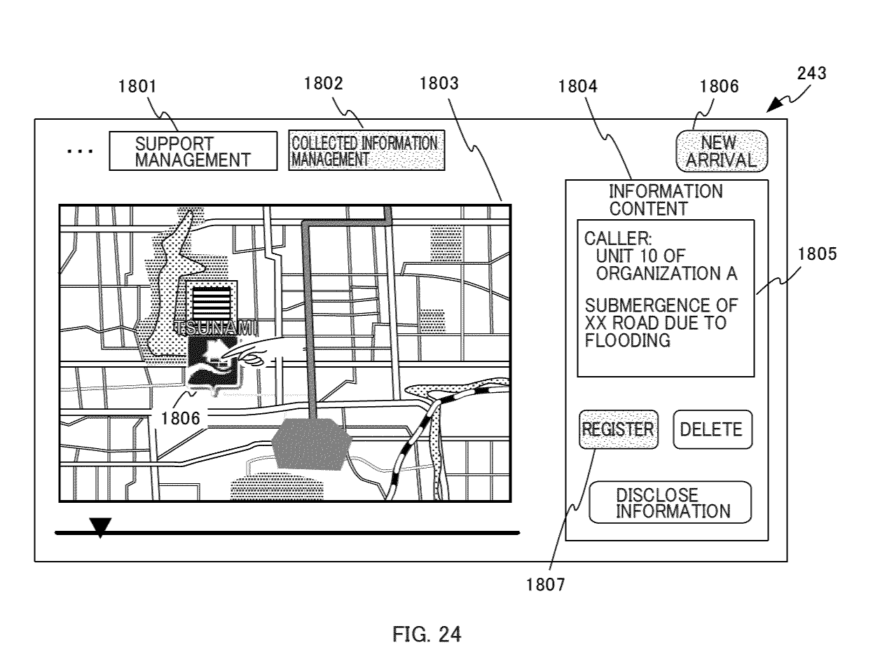

A display screen example of the screen IF 243 during the execution of the above step S1404 is as shown in FIG. 24. The screen display shown in FIG. 24 is just an example. Check boxes, buttons, and display areas forming the screen may be arranged and configured freely. Further, the screen may be divided to multiple sections.

When the collected information management button 1802 is pressed on the screen IF 243, the site responder terminal 109 displays information registered in the collected information DB 255 on the situation finding screen 1803. Here, when information disclosed by a user of the other organization is received from the site coordination device 103, the site responder terminal 109 causes a new arrival button 1806 to turn on. When the new arrival button 1806 is pressed, the site responder terminal 109 displays information received from the site coordination device 103 on the situation finding screen 1803 (for example, symbol 1806). When the symbol 1806 is pressed, the site responder terminal 109 causes the content of information corresponding to the symbol 1806, and information on a user of the information disclosure source to be displayed on the screen 1805. In this case, when the registration button 1807 is pressed, the site responder terminal 109 registers the information selected by pressing the symbol 1806 into the collected information DB 255.

Here, description is made back to the process flow. On the other hand, the information analysis device 152 utilized by the user B2 of the information analyst causes the information analysis function 221 to register, in the analysis result DB 256, the analysis result of damage situations of the disaster and a secondary disaster, and subsequent development range and speed of events thereof estimated from the collected information DB 255 and the analysis result DB 256. A predetermined simulation program may be adopted as an analysis means for acquiring the analysis result in the information analysis device 152. The simulation program forecasts the number of collapsed or partially collapsed houses and human damages therefrom, by using, for example, seismic intensity information on locations registered in the collected information DB 255, and building information (building construction, strength, location ground, and the like) registered in the map DB 251. The simulation program also forecasts tsunami's arrival time and height, inundation range, and human damages therefrom in each harbor from seismic intensity information and seismic center information registered in the collected information DB 255, and topographic information registered in the map DB 251. Further, the simulation program forecasts future fire spread transition by using fire outbreak information and weather information (wind speed, wind direction, rainfall) registered in the collected information DB 255.

The information analysis device 152 causes the analysis result disclosure function 233 to register, in the field “Disclosure Range”, the user authorized to access to analysis results registered in the analysis result DB 256. Information on the user authorized to access may be acquired from the cooperation destination DB 254. The analysis result disclosure function 223 also transmits an analysis result to be disclosed out of analysis results registered in the analysis result DB 256, or information (such as URL) necessary for access to analysis results to be disclosed, to the site coordination device 103 along with information on the user (for example, user A2) authorized to access (S1405). When there are many records of the analysis result to be disclosed, it is preferable to transmit information (such as URL) necessary for access. The transmitted disclosure analysis result is registered in the disclosed information management DB 122 by processing similar to step S1402.

On the other hand, the information analysis device 108 utilized by the user A2 of the information analyst causes the information analysis function 221 to register, in the analysis result DB 256, the analysis result of damage situations of the disaster and a secondary disaster, developments of the events, and impacts thereof on the disaster response estimated from information registered in the collected information DB 255, and the analysis result DB 256 (S1406). At that time, the information analysis device 108 may access to the disclosed information management DB 122 of the site coordination device 103 to acquire the analysis result disclosed by the user B2 if the analysis result of the other organization (for example, user B2) available to the user A2 is disclosed, and utilize the analysis result for the above analysis.

The above analysis result DB 256 comprises, as illustrated in FIG. 22, a field “Result ID” 1641 for identifying each record, a field “Block ID” 1642 for registering the block ID of the area if the analysis result has been converted to a value for each of areas in step S1503, a field “Time” 1643 for registering the time when the record is registered or updated, a field “Type” 1644 for registering the summary of information (for example, such as “fire spread forecast” and “building collapse forecast”), a field “Location” 1645 for registering the place, a field “Value” 1646 for registering the value of the analysis result, and a field “Disclosure Range” 1647 for registering information of the user authorized to access to the record.

Next, the information analysis device 108 utilized by the user A2 of the information analyst causes the impact determination function 222 to calculate the impact by determining, based on the value of the field “Present Location” registered in the resource DB 253, whether the analysis result registered in the analysis result DB 256 in the above step S1406 gives an impact on each site responder (for example, user A3), and if determined that site responders are affected, transmit the analysis result and the impact to the site responder terminal 109 of the user A3 (S1407). At that time, the information analysis device 108 also calculates the impact on a user (for example, user B3) of the other organization registered in the cooperation destination DB 254 by determining whether there is any impact of the analysis result, and if determined that there is an impact, transmits the analysis result and the impact to the site responder terminal 153 utilized by the user B3. This step may be performed at a time when a new analysis result is created in the above step S1406 and registered in the analysis result DB 256, or at a periodical timing. For example, even when the present location of each site responder always changes, this step enables to keep on transmitting a latest impact and thereby prevent each site responder from being involved in a secondary disaster during a disaster response at the disaster-stricken area.

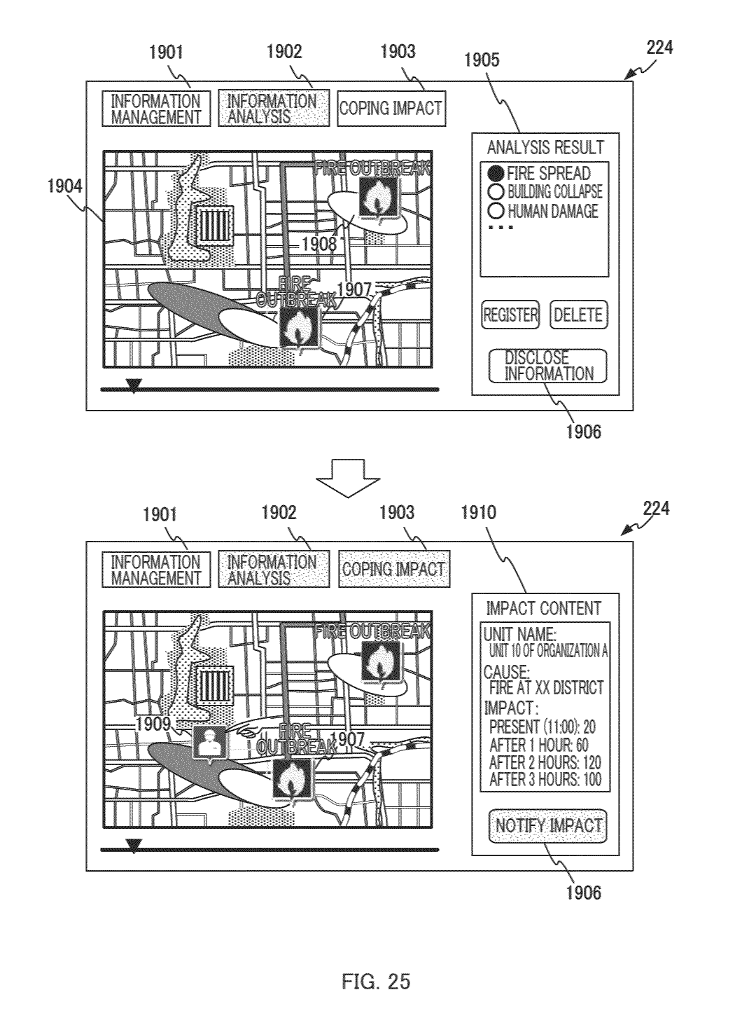

A display screen example of the screen IF 224 during the execution of the above step S1407 is shown in FIG. 25. The screen display shown in FIG. 25 is just an example. Check boxes, buttons, and display areas forming the screen may be arranged and configured freely. Further, the screen may be divided into multiple sections.

When the information analysis button 1902 is pressed on the screen IF 224, the information analysis device 108 causes the analysis result select screen 1905 to be displayed. Here, for example, when “Fire Spread” is selected, the information analysis device 108 displays the fire spread estimate result (for example, objects 1907 and 1908) indicating the range of fire spreading from the fire outbreak point to leeward, on the situation finding screen 1904. Further, when a response impact button 1903 is pressed, the information analysis device 108 displays a user extracted in step S1504 described later on the situation finding screen 1904 (for example, symbol 1909). Further, when the symbol 1909 is pressed, the information analysis device 108 causes information on the impact calculated in step S1505 described later to be displayed on the impact content display screen 1910. Here, when an impact notification button 1906 is pressed, the information analysis device 108 transmits information on the impact to a site responder terminal utilized by the user displayed with the symbol 1909.

Here, description is made back to the process flow. On the other hand, the site responder terminal 109 utilized by the user A3 of the site responder receives the analysis result and the impact transmitted in step S1407, and displays them by the screen IF 243 (S1408). Similarly, the site responder terminal 153 utilized by the user B3 of the site responder receives the analysis result and the impact transmitted in step S1407, and displays them by the screen IF 243 (S1409).

Although information to be disclosed, the analysis result, or information (such as URL) necessary for access to the information to be disclosed and the analysis result, and information on the user authorized to access are transmitted to the site coordination device 103 by the site responder terminal 153 and the information analysis device 152 in the above steps S1401 and S1405, the data management device 154 may transmit the above information to the site coordination device 103 based on the content of the field “Disclosure Range” of each record in the collected information DB 255 and the analysis result DB 256, or information (such as user name) registered in the coordination destination DB 254.

Example of Impact Determination Process Flow

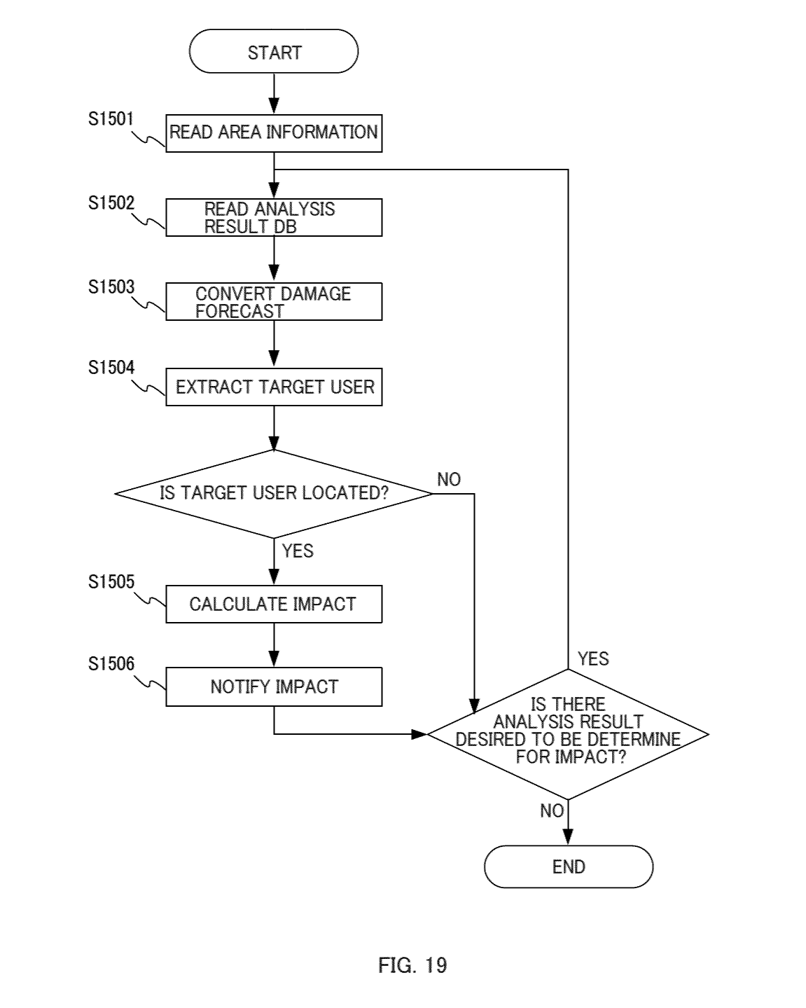

Next, the impact determination process flow in the above step S1407 is described in detail. FIG. 19 is a flowchart showing a procedure example 6 of the decision-making support method according to the embodiment. Specifically, FIG. 19 illustrates the impact determination process flow. In this case, in step S1501, the information analysis device 108 acquires information of each area (identification block ID, latitude and longitude range) from the map DB 251. In step S1502, the information analysis device 108 acquires the analysis result, such as, for example, the fire spread forecast result from the analysis result DB 256.

Next, in step S1503, the information analysis device 108 converts the analysis result acquired in the above step S1502 for each of areas acquired in step S1501. For example, in the case that a fire spread forecast result acquired in step S1502 indicates afire spread area (for example, an area with the block ID=00001) including a point where fire occurs presently, but a subsequent, for example, one-hour-after spread forecast result indicates the fire spread to areas with block IDs=00001 and 00002, the latter areas are converted as the fire spread area. Further, if a three-hour-later fire spread forecast result indicates the fire spread to areas with block IDs=00001, 00002, and 00003, those areas are replaced as the fire spread area.

Next, in step S1504, the information analysis device 108 extracts a target user of the impact determination based on the value of the field “Present Location” of each user registered in the resource DB 253, the cooperation destination DB 254, and the site coordination DB 121 according to analysis results such as the fire spread forecast result for each of areas converted in step S1503.

For example, like the above fire spread forecast result, when a three-hour-later fire spread forecast result indicates the fire spread to three areas with block IDs=00001, 00002, and 00003, a user located in a corresponding area or a user (site responder) located in an adjacent area is extracted as a target user. Here, if there is no target user, and the analysis result includes the other field (such as flood damage forecast) of which impact determination is desired, the information analysis device 108 acquires, in step S1502, an analysis result (such as flood damage forecast) of which impact determination is desired. If there is no field of the analysis result for which impact determination is desired, the information analysis device 108 ends this process flow.

Next, in step S1505, the information analysis device 108 determines the impact on the user extracted in the above step S1504. This determination is performed in such a manner that, for example, if the user extracted in step S1504 is working in an area with the block ID=00003, the present fire spread area is an area with the block ID=00001, and for example, if an area with the block ID=00001 and an area with the block ID=00003 are located apart by “2” from each other, the impact is “20”. Next, assume that if the fire spread area after 1 hour is an area with block IDs=00001 and 00002, and areas with block ID s=00002 and block ID=00003 are located apart by 1″ from each other, the impact on the fire spread area with the block ID=00002 is “40”. Since the impact on the fire spread area with the block ID=00001 is “20”, the one-hour-after impact is determined to be “60” by adding up “40” and “20”. Further, assume that when a fire spread area after 3 hours is an area with the block ID=00001, 00002, and 00003, and an area where the user is working (area with the block ID=00003) overlaps the fire spread area, the impact under this situation is “80”. Then, the three-hour-after impact is determined to be “140” by adding the impact on the fire spread area with block IDs=00001 and 00002.

Next, in step S1506, the information analysis device 108 transmits the impact calculated in step S1505 for the user extracted in step S1504 to a site responder terminals used by the user extracted in step S1504, based on the value of the field “Contact” of users registered in the resource DB 253, and the site coordination DB 121.

This process flow enables to determine how the disaster or the secondary disaster gives impacts (such as the fire spread) on site responders located at the disaster-stricken area, and know not only the present impact but also a future impact. This also leads to the support of the disaster response activity of site responders of the own organization and other cooperating organization, or other impacted organizations, such as prevention of the secondary disaster.

Example of Joint Plan Creation Process Flow

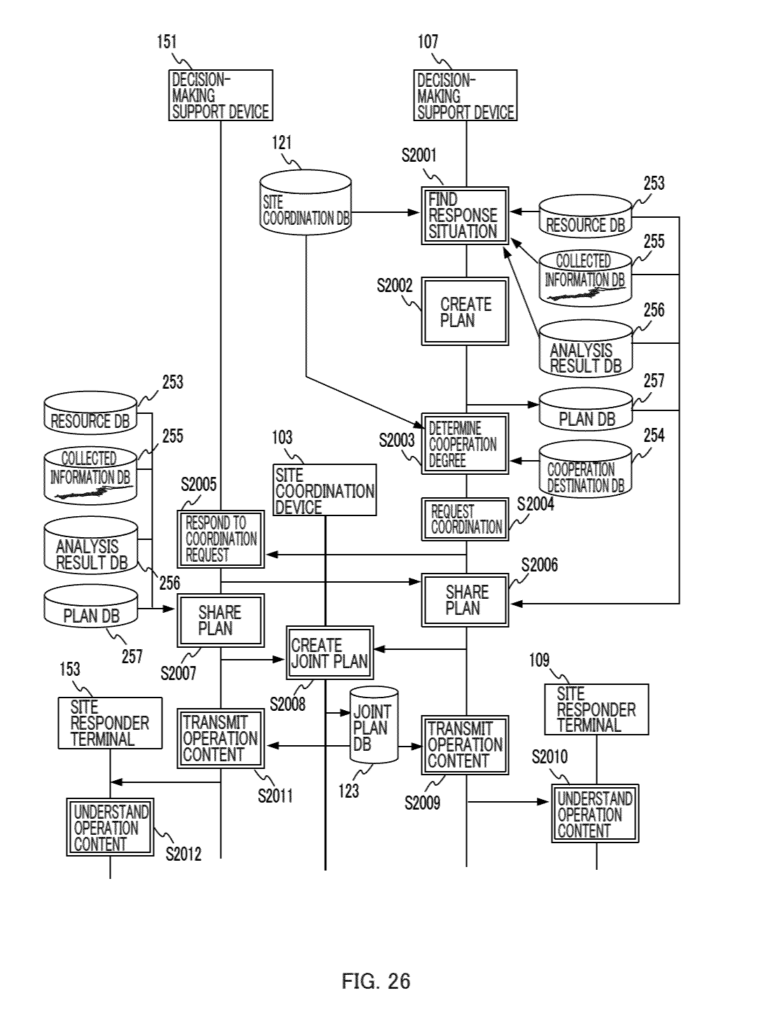

Then, the joint plan creation process flow 304 is described. FIG. 26 is a flowchart showing a processing procedure example 7 of the decision-making support method according to the embodiment. Specifically, FIG. 26 illustrates the joint plan creation process flow.

In this case, the decision-making support device 107 utilized by the user A1 of the decision maker causes the plan creation function 211 to perform a response situation finding (S2001). In the response situation finding, the decision-making support device 107 acquires records stored in the collected information DB 255 and the analysis result DB 256, and displays information contained in the records on the screen IF 215 by mapping with map data, satellite image, and the like stored in the map DB 251. At that time, records displayed on the screen IF 215 may be limited depending on the field name or value range of the record.

The decision-making support device 107 acquires a record relating to each user of the Organization A stored in the resource DB 253, and displays the record on the above screen IF 215 based on the value of the field “Present Location”. Further, the decision-making support device 107 acquires a record relating to a user of the other organization stored in the site coordination DB 121 of the site coordination device 103, and displays the record on the above screen IF 215 based on the value of the field “Present Location”. At that time, the decision-making support device 107 may refer to the cooperation destination DB 254, and display only a record of the user (for example, user B3) registered in the cooperation destination DB 254 on the above screen IF 215 based on the value of the field “Present Location”.

Next, the above decision-making support device 107 causes the plan creation function 211 to accept input of the instruction content (such as, for example, life-saving at ______ Town of ______ City) of the user A1 into the record designated by the user A1 of the decision maker out of records relating to each user of the Organization A displayed in step S2001, and register information of the accepted instruction content into the plan DB 257 (S2002).

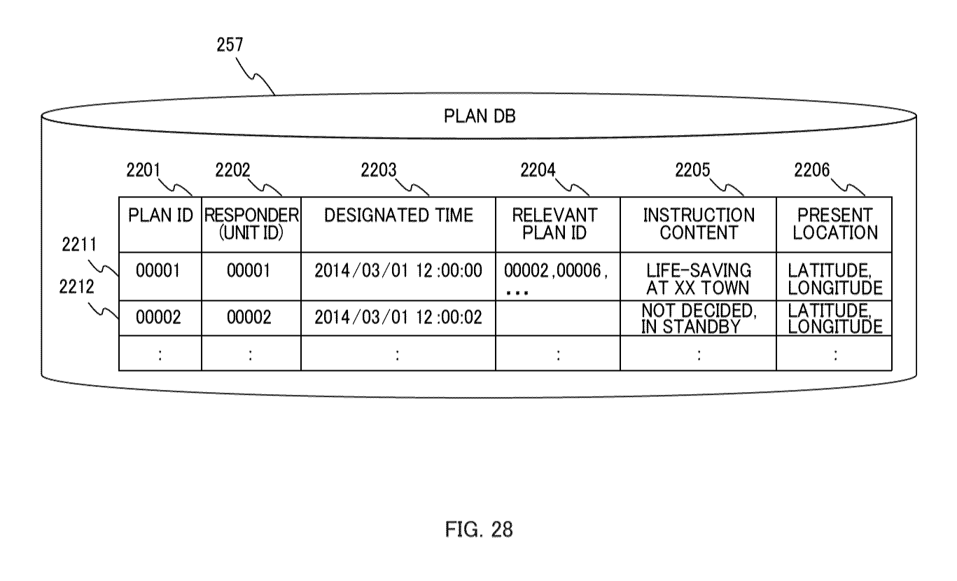

A specific data configuration of the plan DB 257 is as illustrated in FIG. 28. The plan DB 257 comprises a field “Plan ID” 2201 for identifying each record, a field “Accepted by” 2202 for registering the user name (unit name) or unit ID (assigned by the resource DB 253) of the user receiving the work instruction, a field “Instructed Time” 2203 for registering the time when the record is registered or updated, a field “Relevant Plan ID” 2204 for registering the plan ID of the record having a relationship with the other record (work instruction) when two works are performed simultaneously or sequentially, a field “Instruction Content” 2205 for registering the instruction content, and a field “Present Location” 2206 for registering the present location of the user receiving the work instruction.

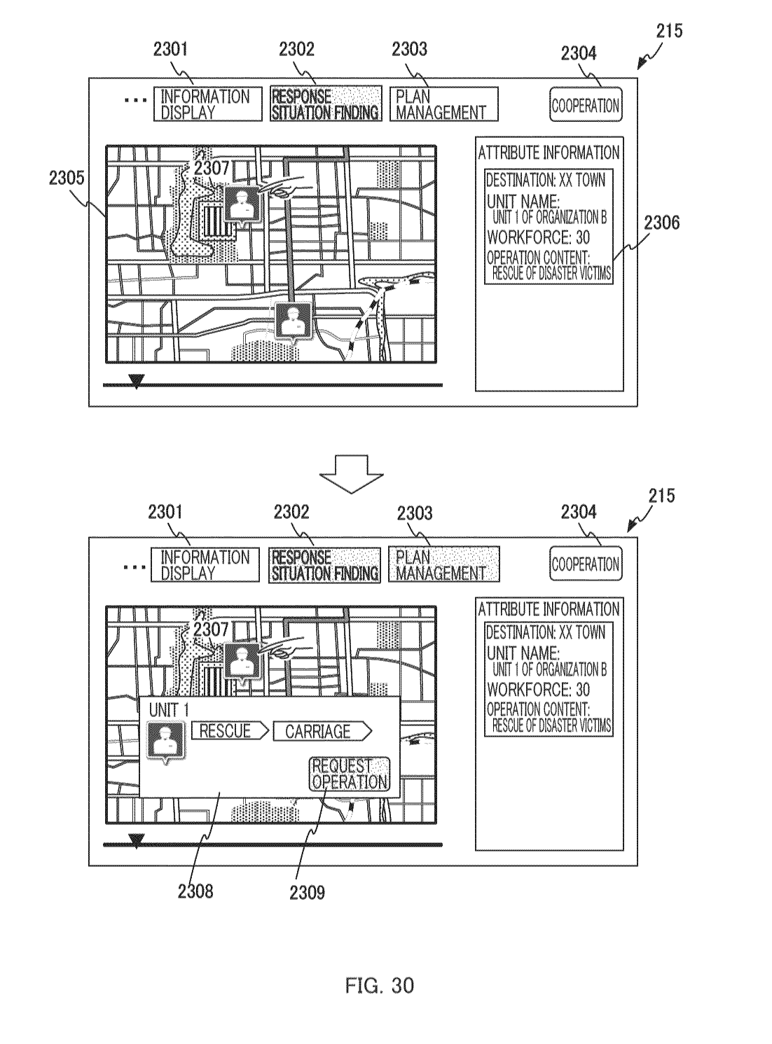

FIG. 30 shows a screen transition example of the screen IF 215 during the execution of the above step S2002. The screen display shown in FIG. 30 is just an example. Check boxes, buttons, and display areas forming the screen may be arranged and configured freely. Further, the screen may be divided into multiple sections.

When the response situation finding button 2302 is pressed on the screen IF 215, the decision-making support device 107 displays, based on the value of the field “Present Location” of records stored in the resource DB 253, a symbol indicating the user of the site responder on a map of the situation finding screen 2305 (for example, symbol 2307). Then, when the symbol 2307 is pressed, the decision-making support device 107 causes the attribute information of a user of a site responder corresponding to the symbol 2307 to be displayed on the attribute information display screen 2306. Next, when the plan management button 2303 is pressed, the decision-making support device 107 causes to display a screen 2308 that accepts input of the instruction content (for example, the operation content such as life-saving at XX Town of YY City, and its sequence) for the user of the site responder corresponding to the symbol 2307. When an operation request button 2309 is pressed, the decision-making support device 107 registers the input information into the plan DB 257. The decision-making support device 107 transmits the input instruction content to a site responder terminal utilized by the user of the site responder corresponding to the symbol 2307.

Here, description is made back to the process flow. The above decision-making support device 107 causes the cooperation degree determining function 212 to calculate, from the attribute information of the user of the Organization A contained in the resource DB 253, and the attribute information of the user of the other organization (for example, Organization B) contained in the site coordination DB 121 of the site coordination device 103, the number of users of the other organization located apart within a predetermined distance from the present location of the user of the Organization A, and determine the cooperation degree with the other organization (for example, Organization B) from the number of users of the other organization registered in the cooperation destination DB 254, and the number of pieces of information of the other organization calculated from the value of the field “Information Acquisition Destination” of each record in the collected information DB 255 (S2003). The detail of the determination is described later.

Next, the decision-making support device 107 causes the plan sharing function 213 to transmit a cooperation and coordination request to the other organization (for example, a decision-making support device 151 utilized by a user B1 of the decision maker of the Organization B) with a high cooperation degree based on the cooperation degree determination result in the above step S2003 (S2004).

On the other hand, the decision-making support device 151 utilized by the user B1 of the decision maker causes the plan sharing function 213 to receive the cooperation and coordination request transmitted in the above step S2004, and if the user B1 being the decision maker determines and indicates through an input device to cooperate with the organization A being the cooperation and coordination request source, notify acceptance of the cooperation and coordination to a decision-making support device 107 utilized by the user A1 of the decision maker being the transmission source of the cooperation and coordination request (S2005).

On the other hand, the decision-making support device 107 utilized by the user A1 of the decision maker causes the plan sharing function 213 to receive the notification about cooperation and coordination acceptance or rejection transmitted in the above step S2005, and if the notification indicates acceptance of the cooperation and coordination, transmit a portion or whole of the disaster response plan registered in the plan DB 257 to site coordination devices 103 under control thereof together with information (organization name) of the cooperation and coordination destination organization (S2006). At that time, a record displayed on the screen IF 215 by processing similar to step S2001 may be transmitted to the site coordination device 103 together with the above disaster response plan. Thus, the user B1 of the decision maker of the cooperation and coordination destination organization (for example, Organization B) can view the same information as viewed by the user A1 of the decision maker.

If acceptance of the cooperation and coordination is transmitted in the above step S2005, the decision-making support device 151 utilized by the user B1 of the decision maker causes the plan sharing function 213 to transmit a portion or whole of the disaster response plan registered in the plan DB 257 to site coordination devices 103 under control together with information (organization name) of the cooperation and coordination destination organization (S2007).

The site coordination device 103 causes the joint plan creation unit 120 to receive information transmitted, for example, in steps S2006 and S2007, and if above organizations A and B cooperate and coordinate with each other, create the joint plan DB 123 for the cooperation and coordination between organizations A and B based on the received information, and register therein information transmitted in steps S2006 and S2007. The site coordination device 103 also provides the decision-making support device 107 utilized by the user A1 of the decision maker, and the decision-making support device 151 utilized by the user B1 of the decision maker with a same screen in which a record registered in the joint plan DB 123 is mapped with map data, satellite image, or the like stored in the map DB 124, accepts input by the user A1 and the user B1, creates a joint plan for the disaster response, and registers the plan in the joint plan DB 123 (S2008).

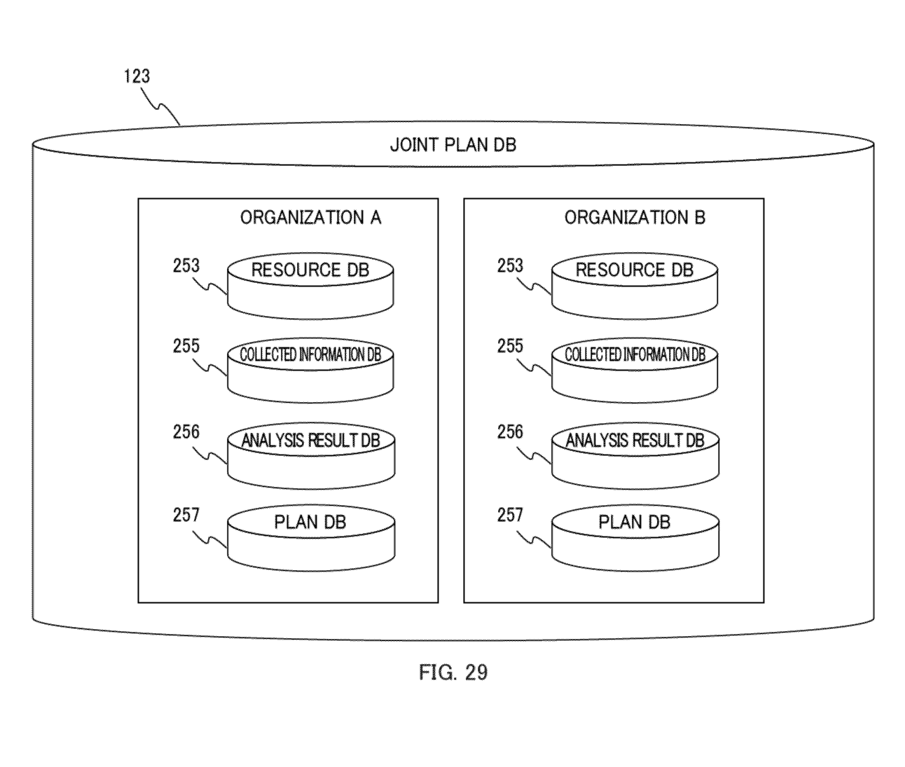

A configuration example of the above joint plan DB 123 may be illustrated in FIG. 29. The joint plan DB 123 is a database that stores a portion or whole of respective resource DBs 253, collected information DBs 255, analysis result DBs 256, and plan DBs 257 transmitted from the decision-making support device 107 of the organization A, and the decision-making support device 151 of the organization B in the above steps S2006, and S2007.

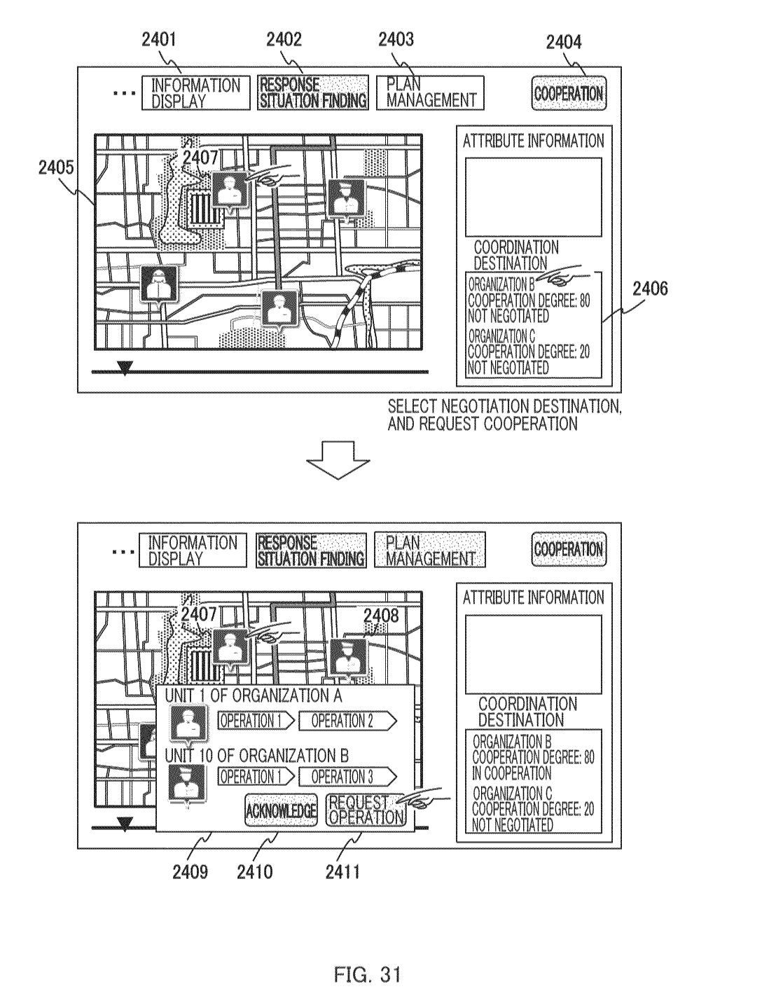

A transition example of the screen IF 215 during the execution of the above steps S2004 and S2008 is shown in FIG. 31. In this case, when the response situation finding button 2402 is pressed on the screen IF 215, the decision-making support device 107 causes to display a symbol indicating the user of the site responder on a map of the situation finding screen 2305 based on the value of the field “Present Location” of the record stored in the resource DB 253 (for example, symbol 2407).

Here, when a cooperation button 2404 is pressed, the decision-making support device 107 displays the cooperation degree for each organization calculated in step S2104 on the cooperation destination display screen 2406. When an organization with the displayed cooperation degree is selected, the decision-making support device 107 transmits a cooperation and coordination request to a decision-making support device utilized by a decision maker of the selected organization.

On the other hand, for example, when a joint plan DB 123 between the Organization A and the Organization B is created in step S2008, the site coordination device 103 causes the screen IF 215 to display a screen in which a record registered in the joint plan DB 123 is mapped with map data, satellite image, or the like stored in the map DB 124. The site coordination device 103 receives, on a screen 2409, input of the instruction content (for example, the operation content such as life-saving at ______ Town of ______ City and its sequence) to a user (for example, symbols 2407, 2408) of a site responder belonging to the cooperating and coordinating organizations A and B. Here, when both of the user of the decision maker of the Organization A and the user of the decision maker of the Organization B press an acknowledge button 2410, the site coordination device 103 activates an operation request button 2411 and accepts press-down thereof. Here, when the operation request button 2411 is pressed, the site coordination device 103 transmits the entered instruction content to a site responder terminal utilized by a user of the site responder corresponding to the symbol 2307 or 2308.

Here, description is made back to the process flow. The decision-making support device 107 utilized by the user A1 of the decision maker causes the work instructing function 214 to transmit information such as the work place, time, operation content to each site responder (for example, site responder terminal 109 utilized by the user A3) based on the joint plan created in the above step S2008 (S2009). On the other hand, the site responder terminal 109 utilized by the user A3 of the site responder causes the instruction content management function 231 to receive information such as the work place, time, and operation content from the above decision-making support device 107 (S2010).

The decision-making support device 151 utilized by the user B1 of the decision maker causes the work instructing function 214 to transmit information such as the work place, time, operation content to each site responder (for example, site responder terminal 153 utilized by the user B3) based on the joint plan created in step S2008 (S2011).

On the other hand, the site responder terminal 153 utilized by the user B3 of the site responder causes the instruction content management function 231 to receive information such as the work place, time, and operation content from the above decision-making support device 151 (S2012).

Although coordination between two organizations including the Organization A and the Organization B is described in the above embodiment, the present invention may apply to a form of cooperation and coordination among at least two organizations.

Example of Cooperation Degree Determination Process Flow

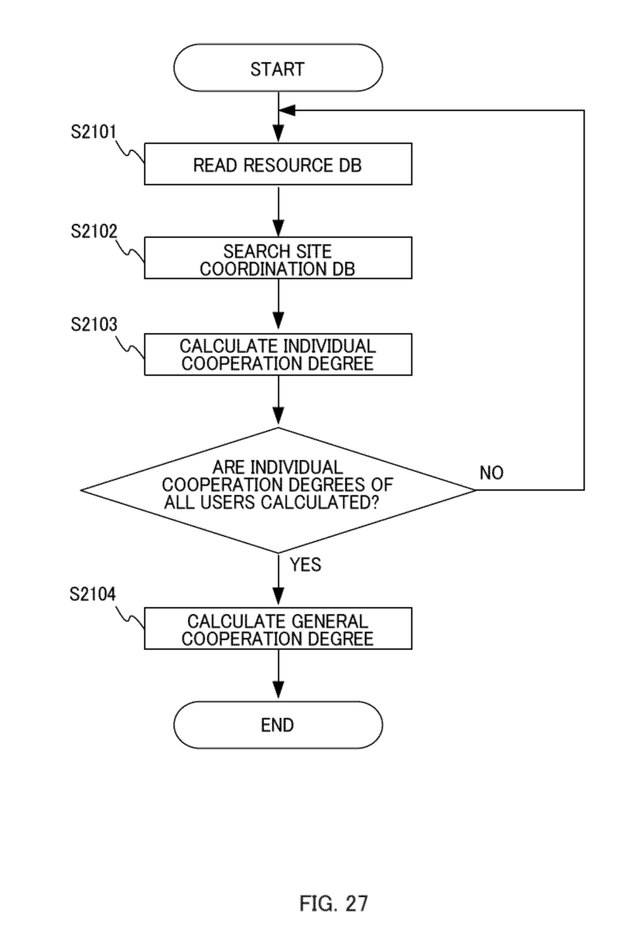

Next, the cooperation degree determination process flow in the above step S2003 is described. FIG. 27 is a flowchart showing a procedure example 8 of the decision-making support method according to the embodiment. Specifically, FIG. 27 illustrates the cooperation degree determination process flow in step S2003.

In this case, in step S2101, the decision-making support device 107 extracts one record (for example, record of the unit ID=00001) out of records registered in the resource DB 253.

Then, in step S2102, the decision-making support device 107 extracts a record having the value of the fields “Present “Location” contained in the record extracted in the above step S2102, and the value of the field “Present Location” indicating a location within a predetermined distance range, from the site coordination DB 121, and calculates the number of extracted records for each of organizations based on the value of the field “Organization Name” of extracted records, such as, for example, Organization B=3, and Organization C=0.

Next, in step S2103, the decision-making support device 107 adds the number of records for each of organizations calculated in the above step S2102 to a corresponding individual cooperation degree. For example, values calculated in step S2102 are added to 0 of the Organization, and C of the Organization C (initial value) to get the individual cooperation degree of 3 for the Organization B, and 0 for the Organization C. Next, the values calculated in step S2102 are added to 3 of the Organization B, and 0 of the Organization C. Here, if there is a record not subjected to the processing of step S2102 out of records registered in the resource DB 253, step S2101 is performed for the record. If there is no record not subjected to the processing of step S2102, the decision-making support device 107 performs step S2104.

Then, in step S2104, the decision-making support device 107 calculates the number of records in the cooperation destination DB 254 for each of organizations based on the value of the field “Organization Name”. For example, the number of records with the field “Organization Name” of “Organization B”, and the number of records with the field “Organization Name” of “Organization C” are calculated. Next, the decision-making support device 107 calculates the cooperation degree for each of organizations from the individual cooperation degree calculated in the above step S2103, and the number of records calculated mentioned above. For example, when the cooperation degree is 80 for the Organization B, and 20 for the Organization C, it is preferable to request cooperation and coordination to the Organization B of the higher cooperation degree. The number of records for each of organizations may be calculated based on the value of the field “Information Acquisition Source” of the collected information DB 255, and the number may be used as input information when calculating the cooperation degree.

This process flow allows the decision maker to promptly determine possibility of coordination with the other organization by examining cooperation and coordination status at the site of the disaster-stricken area while overlooking the entire situation, and cooperate and coordinate with the other organization efficiently and effectively.

Form Compatible with Cloud Service

In the embodiments described above, the decision-making coordination systems respectively installed in and utilized by the Organization A, and the Organization B performing the disaster response are described. However, functions of the component devices of the decision-making support system 10 may be provided on a network as a service by a cloud service provider, and this service may be used via terminals by the Organization A and the Organization B described above.

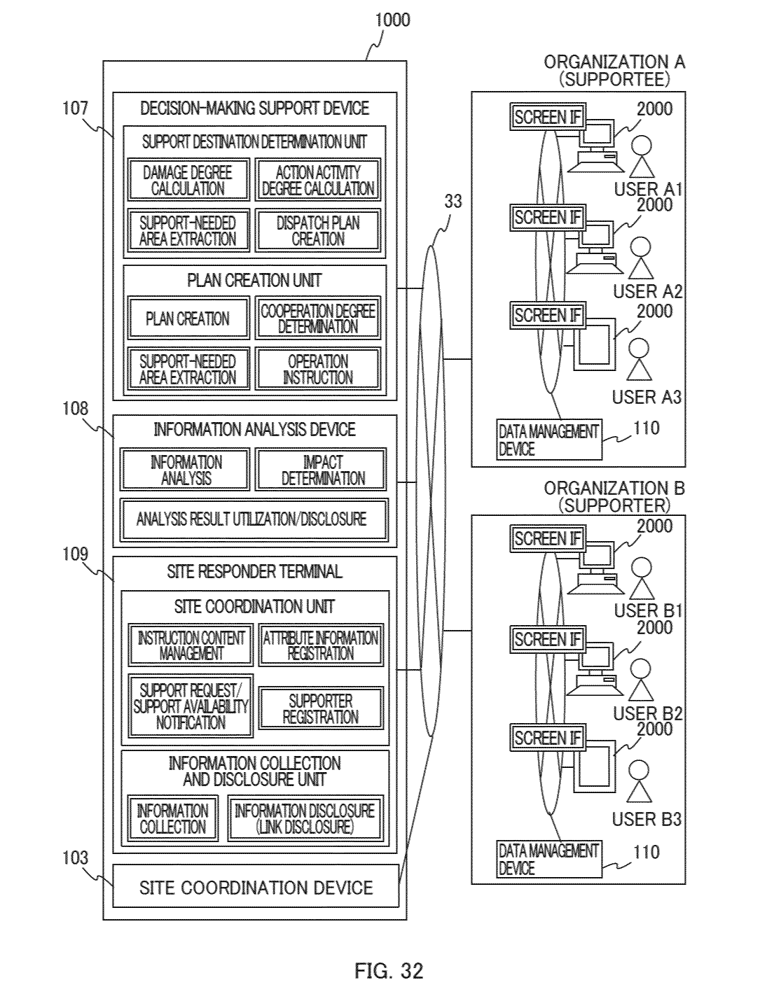

A configuration example of a decision-making coordination system provided by a service provider via a network in such a form is illustrated in FIG. 32.

In this case, a cloud system 1000 comprises a decision-making coordination system 101, and a site coordination device 103 according to the present embodiment and installed in a building or server room owned by a service provider, or in a data center, and provides processing performed by the decision-making coordination system 101, and the site coordination device 103 as services to service users such as organizations A and B via a network 33 such as the internet.

On the other hand, a predetermined terminal 2000 used by a service user (for example, user A1, user A2, and user A3) comprises each database of the screen IF, and the data management device 110 for using the decision-making coordination system 101 and the site coordination device 103 by making access to the cloud system 1000 via the network 33.

Thus, the cloud service providing functions of the decision-making support system according to the present invention significantly reduces costs for system introduction and operation and labor hour compared with the system configuration and operation on the organization basis.

Although best modes for embodying the present invention are described specifically as above, the present invention is not limited thereto, and various modifications are possible within a scope not deviating from the spirit thereof.

Configurations, functions, processing units, processing means, and the like of the embodiments described above may be implemented with hardware in part or as a whole, for example, by designing in an integrated circuit. Also, the above configurations, functions, and the like may be implemented with software that causes a processor to interpret and execute a program implementing respective functions. Information of programs, tables, files, and the like for implementing functions may be stored in a recording device such as a memory, hard disk, and SSD (Solid State Drive), or in a recording medium such as an IC card, a SD card, and DVD. Illustrated control lines and information lines are those deemed to be necessary for the purpose of explanation, and may not include all control lines and information lines necessary for a product. In fact, it may be considered that almost all configurations are connected with each other.

For example, when disaster's scale is large, and there is a need to perform the disaster response with cooperation among multiple organizations, the embodiments described above enable support organizations, located remote from the disaster site without knowing needs of the disaster site, to mutually intervene in the response activity in the disaster-stricken area in an appropriate and smooth manner, and build up a preferable support system. This also enables the supporter and the supportee to promptly establish a cooperative work at the disaster site without awaiting the determination of the decision maker of the relevant organization, and this leads to a prompt and effective rescue of disaster victims. Also, the above decision maker can determine a cooperative activity with the other organization efficiently and effectively in consideration of the cooperation and coordination status among organizations at the disaster site while overlooking the entire situation of the disaster-stricken area, and the own and other organizations.

Accordingly, when making a decision for the disaster response, this enables to establish a cooperation system among organizations in an appropriate and smooth manner, and provide an appropriate support according to actual situations at the disaster-stricken area.

At least the followings are apparent herein. Specifically, the decision-making support system according to the present embodiment may further comprise a site coordination device comprising a storage device configured to store location information and attribute information on each of site responders of various organizations performing a disaster response activity at a disaster-stricken area, and an arithmetic device configured to identify a site responder of another organization located within a predetermined range from a location of a predetermined site responder based on the location information on the site responders, identify, based on the attribute information, a site responder having a activity purpose identical or similar to the predetermined site responder out of the identified site responder of the other organization, and notify information of the identified site responder of the other organization as information of a cooperation and coordination candidate to a site responder terminal used by the predetermined site responder; and a site responder terminal comprising an arithmetic device configured to receive information of the cooperation and coordination candidate from the site coordination device, and according to an instruction from a site responder via a predetermined interface, transmit a cooperation and coordination request for a disaster response activity to a site responder terminal used by a site responder of the other organization being the cooperation and coordination candidate.

This facilitates for site responders having willingness of cooperation and coordination out of site responders acting at the disaster-stricken area to smoothly establish a mutually co-working form while taking a determination of the site responder into account.

Also, the decision-making support system according to the present embodiment may be configured such that the arithmetic device of the site responder terminal further performs processing of receiving the cooperation and coordination request and displaying the cooperation and coordination request on an output device, and upon receipt of a request acceptance response from a site responder via a predetermined interface, transmitting a request acceptance response to a site responder terminal used by a site responder of a cooperation and coordination party, and processing of storing various types of information of the site responder using the site responder terminal, and the site responder of the cooperation and coordination party.

This enables firm and smooth confirmation of the cooperation and coordination willingness among site responders, and registration of information of cooperating and coordinating site responders into a predetermined device.

Also, the decision-making support system according to the present embodiment may be configured such that the arithmetic device of the site coordination device further performs processing of identifying, based on information of a retained resource and a shortage resource in the site responder contained in attribute information on a site responder in the storage device, or contained in a predetermined device on a network, a site responder retaining a predetermined resource as a cooperation and coordination candidate, out of site responders of an organization other than the organization of the predetermined site responder, located within a predetermined range from a location of the predetermined site responder running shortage of a predetermined resource, and notifying information of the identified cooperation and coordination candidate to a site responder terminal of the predetermined site responder.

This enables mutual share of resources (such as workforce, material, equipment, vehicles, food stuff) among site responders working at the disaster-stricken area, and efficient and quick development and progress of the disaster response activity.

Also, the decision-making support system according to the present embodiment may be configured such that the arithmetic device of the site responder terminal further performs processing of acquiring, from a predetermined interface, the location information and the attribute information of a site responder using the site responder terminal, and disclosure range information of the location information and the attribute information on a network, and transmitting the acquired information to the site coordination device, and the arithmetic device of the site coordination device further performs processing of transmitting the location information and the attribute information associated with the disclosure range information, or information for access to the corresponding information to a site responder terminal used by a disclosure target user indicated by the disclosure range information.

This enables an efficient disaster response activity without disclosing information of site responders belonging to the own organization, and without performing various kinds of unnecessary processing involved in the cooperation and coordination, to other organizations not scheduled to coordinate.

The decision-making support system according to the present embodiment may further comprise an information analysis device including an arithmetic device configured to analyze occurrence information of a predetermined event acquired from a predetermined interface with a predetermined algorithm; identify a range of impact by the predetermined event; identify, based on the location information retained by the site coordination device, a site responder located within the range, and an impact by the predetermined event on the site responder; and notify at least information of the predetermined event and an impact thereof to a site responder terminal of the site responder.

This efficiently prevents site responders and the like from suffering a disaster by alerting site responders acting in the area at the time of occurrence of an event such as, for example, a secondary disaster (e.g., fire due to an earthquake) occurring at the disaster-stricken area, or another disaster occurring after elapse of a time at the disaster-stricken area.

The decision-making support system according to the present embodiment may be configured such that the arithmetic device of the information analysis device further performs processing of identifying the impact on a site responder being the cooperation and coordination candidate identified by the site coordination device, and processing of notifying at least information of the predetermined event and an impact thereof to a site responder terminal of the site responder being the cooperation and coordination candidate.

This makes it possible to efficiently avoid suffering of site responders and the like from a disaster by alerting both site responders of the own organization acting at the area, and site responders of the other cooperating and coordinating organization, when the above secondary disaster or the like occurs.

The decision-making support system according to the present embodiment may be configured such that the arithmetic device of the decision-making support device further performs processing of calculating, based on location information and attribute information on each site responder of each organization, the number of site responders of another organization located within a predetermined range of distance from location of a site responder of a predetermined organization, for each other organization, and identifying another organization with the number of site responders equal to or larger than a predetermined criterion as an organization of the cooperation and coordination candidate relating to the disaster response activity, and processing of transmitting a cooperation and coordination request relating to a disaster response activity to the decision-making support device used by the organization of the cooperation and coordination candidate, and the arithmetic device of the decision-making support device used by the organization of cooperation and coordination candidate performs processing of receiving the cooperation and coordination request and displaying the cooperation and coordination request on an output device, and processing of, upon receipt of a request acceptance response from a decision maker via a predetermined interface, transmitting the request acceptance response to a decision-making support device of the organization of a cooperation and coordination party.

This enables firm and smooth establishment of cooperation and coordination among significant organizations.

The decision-making support system according to the present embodiment may be configured such that the arithmetic device of the decision-making support device performs processing of calculating the number of site responders of another organization located within an predetermined range of distance from location of the site responder of the predetermined organization and already cooperating and coordinating with the predetermined organization, for each other organization, and identifying another organization with the calculated number of site responders equal to or larger than a predetermined criterion as an organization of the cooperation and coordination candidate relating to a disaster response activity.

This further enables firm and smooth establishment of cooperation and coordination among significant organizations.

The decision-making support system according to the present embodiment may be configured such that the arithmetic device of the decision-making support device is configured to further perform processing of exchanging decision maker's designation contents of an assigned location, an assigned period of time, and an assigned task of a disaster response for each site responder of an own organization and the other organizations, with the decision-making support device of the other organization that has given the request acceptance response, generating, based on each exchanged designation content, a disaster response plan to be performed by each site responder performing disaster response in cooperation and coordination among organizations, and transmitting a portion or whole of the disaster response plan to the site responder terminal of the relevant site responder of the own organization.

This enables to generate a disaster response plan jointly among cooperating and coordinating organizations, and show to site responders of each cooperating and coordinating organization.

The decision-making support method according to the present embodiment may be configured such that a site coordination device including a storage device configured to store location information and attribute information on each of site responders of various organizations performing a disaster response activity at a disaster-stricken area performs: identifying a site responder of another organization located within a predetermined range from a location of a predetermined site responder based on the location information on the site responders; identifying, based on the attribute information, a site responder having an activity purpose identical or similar to the predetermined site responder out of the identified site responders of the other organization; and notifying information of the identified site responder of the other organization as information of a cooperation and coordination candidate to a site responder terminal used by the predetermined site responder, and the site responder performs: receiving information of the cooperation and coordination candidate from the site coordination device; and according to an instruction from a site responder via a predetermined interface, transmitting a cooperation and coordination request for a disaster response activity to a site responder terminal used by a site responder of the other organization being the cooperation and coordination candidate.

The decision-making support method according to the present embodiment may be configured such that the site responder terminal further performs: processing of receiving the cooperation and coordination request and displaying the cooperation and coordination request on an output device, and upon receipt of a request acceptance response from a site responder via a predetermined interface, transmitting a request acceptance response to a site responder terminal used by a site responder of a cooperation and coordination party, and processing of storing various types of information of the site responder using the site responder terminal, and the site responder of the cooperation and coordination party.

The decision-making support method according to the present embodiment may be configured such that the site coordination device further performs processing of identifying, based on information of a retained resource and a shortage resource in the site responder contained in attribute information on a site responder in the storage device, or contained in a predetermined device on a network, a site responder retaining a predetermined resource as a cooperation and coordination candidate, out of site responders of organizations other than the organization of the predetermined site responder, located within a predetermined range from a location of a predetermined site responder running shortage of a predetermined resource; and notifying information of the identified cooperation and coordination candidate to a site responder terminal of the predetermined site responder.

What is claimed is:

1. A decision-making support system, comprising:
a decision-making support device comprising
a storage device configured to store a predetermined criterion defining a damage degree according to a content of each of disasters, and predetermined information symbolizing various human activities in disasters, and
an arithmetic device configured to
determine a damage degree for each of areas in a disaster-stricken area by comparing disaster information acquired via a predetermined interface with the predetermined criterion,
determine an activity degree of human activities at each of the areas based on appearance frequency of the predetermined information in various types of information acquired from the predetermined interface or the disaster information,
identify, as a support-needed area, an area with a higher damage degree and a lower activity degree than those of other areas, or an area with the damage degree and the activity higher by a predetermined level or more than those of other areas, and
output information of the support-needed area to a predetermined device.

2. The decision-making support system according to claim 1, further comprising:
a site coordination device comprising
a storage device configured to store location information and attribute information on each of site responders of various organizations performing a disaster response activity at a disaster-stricken area, and
an arithmetic device configured to
identify a site responder of another organization located within a predetermined range from a location of a predetermined site responder based on the location information on the site responders,
identify, based on the attribute information, a site responder having a activity purpose identical or similar to the predetermined site responder out of the identified site responder of the other organization, and
notify information of the identified site responder of the other organization as information of a cooperation and coordination candidate to a site responder terminal used by the predetermined site responder; and
a site responder terminal comprising
an arithmetic device configured to
receive information of the cooperation and coordination candidate from the site coordination device, and according to an instruction from a site responder via a predetermined interface, transmit a cooperation and coordination request for a disaster response activity to a site responder terminal used by a site responder of the other organization being the cooperation and coordination candidate.

3. The decision-making support system according to claim 2, wherein the arithmetic device of the site responder terminal further performs
processing of receiving the cooperation and coordination request and displaying the cooperation and coordination request on an output device, and upon receipt of a request acceptance response from a site responder via a predetermined interface, transmitting a request acceptance response to a site responder terminal used by a site responder of a cooperation and coordination party, and
processing of storing various types of information of the site responder using the site responder terminal, and the site responder of the cooperation and coordination party.

4. The decision-making support system according to claim 3, wherein
the arithmetic device of the site coordination device further performs processing of
identifying, based on information of a retained resource and a shortage resource in the site responder contained in attribute information on a site responder in the storage device, or contained in a predetermined device on a network, a site responder retaining a predetermined resource as a cooperation and coordination candidate, out of site responders of an organization other than the organization of the predetermined site responder, located within a predetermined range from a location of the predetermined site responder running shortage of a predetermined resource, and
notifying information of the identified cooperation and coordination candidate to a site responder terminal of the predetermined site responder.

5. The decision-making support system according to claim 3, wherein
the arithmetic device of the site responder terminal further performs processing of
acquiring, from a predetermined interface, the location information and the attribute information of a site responder using the site responder terminal, and disclosure range information of the location information and the attribute information on a network, and
transmitting the acquired information to the site coordination device, and
the arithmetic device of the site coordination device further performs processing of
transmitting the location information and the attribute information associated with the disclosure range information, or information for access to the corresponding information to a site responder terminal used by a disclosure target user indicated by the disclosure range information.

6. The decision-making support system according to claim 3, further comprising:
an information analysis device including
an arithmetic device configured to
analyze occurrence information of a predetermined event acquired from a predetermined interface with a predetermined algorithm,
identify a range of impact by the predetermined event,
identify, based on the location information retained by the site coordination device, a site responder located within the range, and an impact by the predetermined event on the site responder, and
notify at least information of the predetermined event and an impact thereof to a site responder terminal of the site responder.

7. The decision-making support system according to claim 6, wherein
the arithmetic device of the information analysis device further performs
processing of identifying the impact on a site responder being the cooperation and coordination candidate identified by the site coordination device, and processing of notifying at least information of the predetermined event and an impact thereof to a site responder terminal of the site responder being the cooperation and coordination candidate.

8. The decision-making support system according to claim 3, wherein
the arithmetic device of the decision-making support device further performs
processing of calculating, based on location information and attribute information on each site responder of each organization, the number of site responders of another organization located within a predetermined range of distance from location of a site responder of a predetermined organization, for each other organization, and identifying another organization with the number of site responders equal to or larger than a predetermined criterion as an organization of the cooperation and coordination candidate relating to the disaster response activity, and
processing of transmitting a cooperation and coordination request relating to a disaster response activity to the decision-making support device used by the organization of the cooperation and coordination candidate, and
the arithmetic device of the decision-making support device used by the organization of cooperation and coordination candidate performs
processing of receiving the cooperation and coordination request and displaying the cooperation and coordination request on an output device, and upon receipt of a request acceptance response from a decision maker via a predetermined interface, transmitting the request acceptance response to a decision-making support device of the organization of a cooperation and coordination party.

9. The decision-making support system according to claim 8, wherein
the arithmetic device of the decision-making support device performs
processing of calculating the number of site responders of another organization located within an predetermined range of distance from location of the site responder of the predetermined organization and already cooperating and coordinating with the predetermined organization, for each other organization, and identifying another organization with the calculated number of site responders equal to or larger than a predetermined criterion as an organization of the cooperation and coordination candidate relating to a disaster response activity.

10. The decision-making support system according to claim 8, wherein the arithmetic device of the decision-making support device is configured to further perform processing of exchanging decision maker's designation contents of an assigned location, an assigned period of time, and an assigned task of a disaster response for each site responder of a certain organization and the other organizations, with the decision-making support device of the other organization that has given the request acceptance response, generating, based on each exchanged designation content, a disaster response plan to be performed by each site responder performing disaster response in cooperation and coordination among organizations, and transmitting a portion or whole of the disaster response plan to the site responder terminal of the relevant site responder of the certain organization.

11. A decision-making support system comprising:
a server device configured to provide, on a network, at least any one of a decision-making support device, a site coordination device, a site responder terminal, and an information analysis device, as a cloud service; and
a user terminal configured to access to the server device and utilize the cloud service for at least any one of the decision-making support device, the site coordination device, the site responder terminal, and the information analysis device, wherein
the decision-making support device includes:
a storage device configured to store a predetermined criterion defining a damage degree according to a content of each of disasters, and predetermined information symbolizing various human activities in disasters; and
an arithmetic device configured to
determine a damage degree for each of areas at a disaster-stricken area by comparing disaster information acquired from a predetermined interface with the predetermined criterion,
determine an activity degree of human activities for each of the areas based on appearance frequency of the predetermined information in various types of information acquired from a predetermined interface or the disaster information, and
identify, as a support-needed area, an area with a higher damage degree and a lower activity degree than other areas, or an area with the damage degree and the activity degree higher by a predetermined level or more than those of other areas, and
output information of the support-needed area to a predetermined device,
the site coordination device includes:
a storage device configured to store location information and attribute information on each of site responders of various organizations performing a disaster response activity at a disaster-stricken area; and
an arithmetic device configured to
identify a site responder of another organization located within a predetermined range from a location of a predetermined site responder based on the location information on the site responders;
identify, based on the attribute information, a site responder having an activity purpose identical or similar to the predetermined site responder out of the identified site responders of the other organization; and
notify information of the identified site responder of the other organization as information of a cooperation and coordination candidate to a site responder terminal used by the predetermined site responder,
the site responder terminal includes
an arithmetic device configured to
receive information of the cooperation and coordination candidate from the site coordination device, and according to an instruction from a site responder via a predetermined interface, transmit a cooperation and coordination request for a disaster response activity to a site responder terminal used by a site responder of the other organization being the cooperation and coordination candidate, and
the information analysis device includes
an arithmetic device configured to
analyze occurrence information of a predetermined event acquired from a predetermined interface with a predetermined algorithm,
identify a range of impact by the predetermined event,
identify, based on the location information retained in the site coordination device, a site responder located in the range, and an impact of the predetermined event on the site responder, and
notify at least information of the predetermined event and an impact thereof to a site responder terminal of the site responder.

12. A decision-making support method wherein a decision-making support device including a storage device configured to store a predetermined criterion defining a damage degree according to a content of each of disasters performs:
determining a damage degree for each of areas at a disaster-stricken area by comparing disaster information acquired from a predetermined interface with the predetermined criterion;
determining an activity degree of human activities for each of the areas based on appearance frequency of the predetermined information in various types of information acquired from the predetermined interface or the disaster information;
identifying, as a support-needed area, an area with a higher damage degree and a lower activity degree than those of other areas, or an area with the damage degree and the activity degree higher by a predetermined level or more than those of other areas; and
outputting information of the support-needed area to a predetermined device.

13. The decision-making support method according to claim 12, wherein
a site coordination device including a storage device configured to store location information and attribute information on each of site responders of various organizations performing a disaster response activity at a disaster-stricken area performs:
identifying a site responder of another organization located within a predetermined range from a location of a predetermined site responder based on the location information on the site responders;
identifying, based on the attribute information, a site responder having an activity purpose identical or similar to the predetermined site responder out of the identified site responders of the other organization; and
notifying information of the identified site responder of the other organization as information of a cooperation and coordination candidate to a site responder terminal used by the predetermined site responder, and
the site responder performs:
receiving information of the cooperation and coordination candidate from the site coordination device; and according to an instruction from a site responder via a predetermined interface, transmitting a cooperation and coordination request for a disaster response activity to a site responder terminal used by a site responder of the other organization being the cooperation and coordination candidate.

14. The decision-making support method according to claim 13, wherein
the site responder terminal further performs:
processing of receiving the cooperation and coordination request and displaying the cooperation and coordination request on an output device, and upon receipt of a request acceptance response from a site responder via a predetermined interface, transmitting a request acceptance response to a site responder terminal used by a site responder of a cooperation and coordination party, and
processing of storing various types of information of the site responder using the site responder terminal, and the site responder of the cooperation and coordination party.

15. The decision-making support method according to claim 14, wherein
the site coordination device further performs processing of
identifying, based on information of a retained resource and a shortage resource in the site responder contained in attribute information on a site responder in the storage device, or contained in a predetermined device on a network, a site responder retaining a predetermined resource as a cooperation and coordination candidate, out of site responders of organizations other than the organization of the predetermined site responder, located within a predetermined range from a location of a predetermined site responder running shortage of a predetermined resource; and
notifying information of the identified cooperation and coordination candidate to a site responder terminal of the predetermined site responder.
